(19) United States
(12) Patent Application Publication
(10) Pub. No.: US 2026/0219886 A1
(43) Pub. Date: Jul. 30, 2026

(54) EXPANDABLE INSTRUCTION SET

(71) Applicant: Arm Limited, Cambridge (GB)

(72) Inventors: Thomas Philip SPEIER, Wake Forest, NC (US); Richard Roy GRISENTHWAITE, Cambridge (GB); Andrew Christopher ROSE, Great Shelford (GB)

(21) Appl. No.: 19/040,988

(22) Filed: Jan. 30, 2025

(51) Int. Cl. G06F 9/30; G06F 9/38

(52) U.S. Cl. CPC G06F 9/30145; G06F 9/30047; G06F 9/3861

(57) ABSTRACT

An apparatus comprises front end circuitry configured to fetch and decode instructions; and processing circuitry to perform data processing operations in response to instructions decoded by the front end circuitry. In an expandable instruction set mode, the front end circuitry decodes the instructions according to an instruction encoding scheme in which each instruction is required to meet an architectural encoding constraint requiring that, for a given instruction processed in the expandable instruction set mode: the given instruction comprises a set of functional bits representing functionality of the given instruction, and a set of one or more expansion bits; and the set of one or more expansion bits is constrained to specify a predetermined value.

### BACKGROUND

### Technical Field

The present technique relates to the field of data processing.

### Technical Background

A data processing apparatus has processing circuitry to perform data processing in response to instructions decoded by an instruction decoder. The format of the instruction encoding and the functionality represented by each instruction may be defined according to an instruction set architecture (ISA). The ISA represents the agreed framework between the hardware manufacturer who manufactures the processing hardware for a given processor implementation and the software developer who writes code to execute on that hardware, so that code written according to the ISA will function correctly on hardware supporting that ISA. When designing an ISA, there can be a significant design challenge in determining how to implement the instruction set supported by the processing apparatus, including deciding the instruction length for the instructions, the set of processing operations to be supported in the instruction set, and the particular encoding of the instructions which represent those operations. Design decisions made when designing the ISA may have a significant impact on the circuit area and power consumption incurred on hardware which implements the ISA, and on processing performance experienced by software that is written in accordance with the ISA. An ISA may define architectural constraints to be satisfied by hardware designers, which can leave some flexibility for different hardware implementations to take different approaches for satisfying those constraints, e.g. with one hardware implementation prioritising improved processing performance over circuit area/power efficiency, and another hardware implementation prioritising a reduction in circuit area and power consumption even if that is at the expense of reduced processing performance.

### SUMMARY

At least some examples of the present technique provide an apparatus comprising: front end circuitry configured to fetch and decode instructions; and processing circuitry to perform data processing operations in response to instructions decoded by the front end circuitry; in which: in an expandable instruction set mode, the front end circuitry is configured to decode the instructions according to an instruction encoding scheme in which each instruction is required to meet an architectural encoding constraint requiring that, for a given instruction processed in the expandable instruction set mode: the given instruction comprises a set of functional bits representing functionality of the given instruction, and a set of one or more expansion bits; and the set of one or more expansion bits is constrained to specify a predetermined value.

At least some examples of the present technique provide a system comprising: the apparatus described above, implemented in at least one packaged chip; at least one system component; and a board, wherein the at least one packaged chip and the at least one system component are assembled on the board.

At least some examples of the present technique provide a chip-containing product comprising the system described above, wherein the system is assembled on a further board with at least one other product component.

At least some examples provide computer-readable code for fabrication of an apparatus as described above. The computer-readable code may be stored on a computer-readable storage medium. The storage medium may be a non-transitory storage medium.

At least some examples of the present technique provide a computer program comprising instructions which, when executed by a host data processing apparatus, control the host data processing apparatus to provide an instruction execution environment for execution of target program code, the computer program comprising: front end program logic configured to fetch and decode instructions of the target program code; and processing program logic configured to control the host data processing apparatus to perform data processing operations in response to the instructions fetched and decoded by the front end program logic; in which: in an expandable instruction set mode, the front end program logic is configured to decode the instructions according to an encoding scheme in which each instruction is required to meet an architectural encoding constraint requiring that, for a given instruction processed in the expandable instruction set mode: the given instruction comprises a set of functional bits representing functionality of the given instruction, and a set of one or more expansion bits; and the set of one or more expansion bits is constrained to specify a predetermined value.

The computer program may be stored on a computer-readable storage medium. The storage medium may be a non-transitory storage medium.

At least some examples of the present technique provide a method comprising: fetching and decoding instructions using front end circuitry; and in response to the instructions fetched and decoded by the front end circuitry, performing data processing operations using processing circuitry; in which: in an expandable instruction set mode, the instructions are decoded according to an instruction encoding scheme in which each instruction is required to meet an architectural encoding constraint requiring that, for a given instruction processed in the expandable instruction set mode: the given instruction comprises a set of functional bits representing functionality of the given instruction, and a set of one or more expansion bits; and the set of one or more expansion bits is constrained to specify a predetermined value.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of an apparatus comprising front end circuitry and processing circuitry;

FIG. 2 illustrates an example of an instruction to be processed in an expandable instruction set mode;

FIG. 3 illustrates how the expandable instruction set enables subsequent versions of an ISA to expand the number of functional bits used to encode functionality of instructions, while ensuring that hardware and software designed using different versions of the ISA can remain inter-operable;

FIG. 4 illustrates an example of pre-decoding, caching, fetching, and decoding instructions in the expandable instruction set mode;

FIG. 5 illustrates a more detailed example of a processing apparatus;

FIG. 6 illustrates a method comprising steps for processing an instruction in the expandable instruction set mode;

FIG. 7 illustrates an example of an instruction to be processed in a container-based instruction set mode;

FIG. 8 illustrates an example encoding of a program counter for the container-based instruction set mode;

FIG. 9 illustrates an example of advancing the program counter by a variable increment according to a cyclic pattern corresponding to alignment of instructions within a container;

FIG. 10 illustrates program counter advancement circuitry;

FIG. 11 illustrates a method comprising steps for processing an instruction in the container-based instruction set mode;

FIG. 12 illustrates an example of an instruction in a container-based expandable instruction set mode, which combines techniques used in the previous examples;

FIG. 13 illustrates an example of use of memory compression circuitry to compress a block of instructions stored in memory to eliminate expansion bits and/or unused bits of stored instruction sets;

FIG. 14 illustrates an example of reusing unused bits of a container to encode a software-specified value to be reported to software in response to an exception occurring for any instruction within the container;

FIG. 15 illustrates a system and a chip-containing product; and

FIG. 16 illustrates a simulation example.

### DESCRIPTION OF EXAMPLES

Instruction set architecture (ISA) designers may face pressure to add new instructions to the instruction set supported by a processing apparatus, but may need to balance the performance benefits to software expected from any additional instructions with the hardware cost of increased complexity for processor hardware designers to implement new instructions. For any given instruction length, there is a limited amount of encoding space. Simply increasing the instruction length to accommodate new instructions may impose additional hardware costs, from the circuit area and power incurred in storing wider instructions in caches and memory, wider signal paths for passing instructions from one location to another, and more complex instruction decoding circuit logic.

In examples discussed below, an apparatus comprises front end circuitry configured to fetch and decode instructions; and processing circuitry to perform data processing operations in response to instructions decoded by the front end circuitry.

In an expandable instruction set mode, the front end circuitry is configured to decode the instructions according to an instruction encoding scheme in which each instruction is required to meet an architectural encoding constraint requiring that, for a given instruction processed in the expandable instruction set mode: the given instruction comprises a set of functional bits representing functionality of the given instruction, and a set of one or more expansion bits. The set of one or more expansion bits is constrained to specify a predetermined value.

This ISA encoding approach provides a scalable instruction set with room for future expansion since, while any individual processor apparatus may support a given version of the ISA having a defined number of expansion bits in the instruction set, later iterations of the ISA may reduce the number of expansion bits in use from one version to another, converting at least one bit previously used as an expansion bit to become an additional functional bit to increase the range of instruction types that can be supported. In typical instruction sets, while there might be some isolated pockets of reserved encoding space not representing valid instructions, those pockets may be non-contiguous in encoding space with the bits used to denote a reserved instruction encoding in one instruction type being at different bit positions from those bits used to denote a reserved instruction encoding in another instruction type, so that all bits of the instruction may still be needed to be decoded to be able to identify the functionality of the instruction. In contrast, in the expandable instruction set mode, each valid instruction processed in that mode has a set of one or more expansion bits which is constrained to specify the predetermined value. This enables opportunities for hardware designers to limit the hardware cost for circuitry implementing the instruction set during earlier iterations of the ISA (when it is not yet needed to use up all expansion bits for encoding functional bits of instructions). As the hardware can expect each instruction to meet the architectural constraint that the one or more expansion bits specify the predetermined value, those expansion bits do not need to be explicitly represented in stored or signalled representations of the instruction, and so the expandable instruction set mode enables hardware designers, if they wish, to implement circuitry for compressing out the expansion bits when storing the instructions in memory and/or instruction caches or when an instruction passes along a signal path. Hence, this approach provides an ISA which provides a better balance between hardware cost and flexibility for future instruction set expansion.

The front end circuitry may signal an exception in response to detecting an attempt to fetch for processing an instruction having an invalidly-encoded set of one or more expansion bits specifying a value other than the predetermined value. This can be helpful for ensuring compatibility between a legacy processor implementation designed to handle an earlier version of the expandable ISA (with a greater number of expansion bits per instruction) and software that is written according to a later version of the expandable ISA (with fewer expansion bits per instruction). By signalling an exception if an instruction is detected which has its expansion bits set to a value other than the predetermined value (which will typically be a newer instruction added in the later ISA version which would not be supported in hardware by the processor implementation supporting the earlier ISA version), this enables exception handling software to deal with the occurrence of the unsupported instruction, e.g. by emulating the unsupported instruction using one or more other instructions that are supported by the processor hardware.

The exception may be a synchronous exception associated with information identifying a point of program flow associated with the instruction having the invalidly-encoded set of one or more expansion bits. For example, the information identifying the point of program flow can be a program counter value. This information may be stored to a control register or other storage location in response to occurrence of the exception. By raising a synchronous exception (rather than an asynchronous exception not associated with any specific point in program flow), an exception handler can identify the specific instruction that caused the exception, to allow the exception handler to determine how to emulate the instruction that caused the exception when it is determined that the exception occurred because the expansion bits of the instruction were set to a value other than the predetermined value.

In some examples, the front end circuitry comprises an instruction cache configured to cache instructions fetched from a memory system; and pre-decoding circuitry configured to pre-decode an instruction allocated to the instruction cache and to eliminate at least a subset of the set of one or more expansion bits from cached information representing that instruction in the instruction cache. Hence, by eliminating at least a subset of the expansion bits from the stored representation of the instruction in the instruction cache, the number of cached bits per instruction required for the instruction cache can be reduced, reducing the circuit area and power cost of implementing a cache supporting a certain maximum number of instructions (or conversely, increasing the maximum number of instructions that can be cached for a certain circuit area and power budget). Either way, this can improve the ratio between performance uplift achieved by instruction caching and the circuit area and power consumed in achieving that performance uplift. It will be appreciated that while compressing the instruction representation stored in the instruction cache is desirable, and likely in many implementations, it is not essential for implementing the architectural constraints defined by the ISA for the expandable instruction set mode, so some implementations may choose not to implement such compression at the pre-decoding stage, and instead simply cache the full instruction including its expansion bits in an instruction cache. Even if some system implementations choose not to implement such pre-decoding compression, an ISA designed to support the expandable instruction set mode is still an improved ISA over alternative ISAs, because it gives the flexibility for a subset of system designers to choose to compress out the expansion bits at the pre-decoding stage, which would not be possible in alternative ISAs which do not provide an instruction set with expansion bits constrained to a predetermined value for each instruction.

In an implementation which compresses instructions in the instruction cache by eliminating at least one expansion bit at the pre-decoding circuitry prior to allocating the instruction into the instruction cache, it can be useful for the pre-decoding circuitry to generate pre-decode information specifying whether the set of one or more expansion bits for the target instruction have the predetermined value, with the pre-decode information being cached in the instruction cache for the corresponding instruction. This can be helpful to enable the exception mentioned earlier to be generated synchronously at the time of an attempt to fetch a target instruction from the instruction cache (even when the expansion bits used to detect the exception are not themselves cached in the instruction cache), rather than generating the exception corresponding to an invalidly encoded instruction at the pre-decode stage when the expansion bits are obtained from memory and eliminated from the cached representation of the instruction. Generating the exception synchronously tied to a point in program flow at which the instruction is actually attempted to be fetched can be more helpful for a software exception handler than generating the exception as an asynchronous exception based on pre-decoding (since the pre-decoding operation might be triggered by an instruction prefetch operation not tied to any specific point in program flow, so may not allow for generation of a synchronous exception).

The stored pre-decode information could be encoded in different ways, to represent whether the expansion bits for the target instruction have the predetermined value. In some examples, the pre-decode information may be separate from the functional bits of the target instruction, e.g. providing at least one additional bit stored alongside the functional bits to indicate whether the expansion bits eliminated at the pre-decode stage had the predetermined value. In other examples, in a case when the pre-decode circuitry detects during pre-decoding that the one or more expansion bits do not have the predetermined value (so that the target instruction is invalidly encoded for this particular hardware implementation), then the functional bits of the target instruction could be modified to a given reserved value not corresponding to any valid encoding of the functional bits, so that on an instruction fetch of the functional bits of the target instruction, decoding circuitry provided by the front end circuitry may detect the invalid encoding specifying the given reserved value, and then signal the exception. Hence, in some examples, the pre-decode information could comprise the functional bits of the target instruction itself.

The one or more expansion bits are architecturally constrained to have the predetermined value. The predetermined value can be represented by any arbitrary pattern of bit values represented by the one or more expansion bits. The ISA may define which specific encoding of the expansion bits is to be treated as the predetermined value, so that pre-decoding circuitry (decoding circuitry operating prior to instruction caching) or decoding circuitry (decoding circuitry operating after instruction caching) can have circuit logic to check for that encoding of the expansion bits.

However, one particularly efficient encoding of the expansion bits can be where the predetermined value has an encoding for which each of the set of one or more expansion bits is 0. This can enable simpler circuitry for pre-decoding and/or decoding the instructions of the expandable instruction set, since it means the instructions with invalidly encoded expansion bits can be determined simply by detecting whether any of the expansion bits is set to 1. Another alternative could be for the predetermined value to correspond to all expansion bits being set to 1. If all expansion bits take the same bit value in the predetermined value, this simplifies compressing stored forms of the instruction, since an OR or AND reduction of the expansion bits may generate a bit value indicating whether all expansion bits have the predetermined value (OR reduction if that value is 0 or AND reduction if that value is 1).

The expandable instruction set processed in the expandable instruction set mode may be a fixed-length instruction set, for which each instruction of the expandable instruction set has the same number of functional bits (for a given implementation of the hardware of the front end circuitry and processing circuitry). Although that number of functional bits may vary over time from one version of the ISA to another, for any given processing implementation supporting a particular version of the ISA, the number of functional bits is the same number, W, for each instruction of the expandable instruction set.

In some examples, W may be a power-of-2 integer.

However, the use of the expandable instruction set can be particularly useful in cases where W, the number of functional bits per instruction, is a non-power-of-2 integer. As explained in more detail below, instruction sets based on a fixed non-power-of-2 instruction length are often less preferred, as they can cause hardware implementation difficulties because the non-power-of-2 length instructions may, if disposed contiguously in address space, have an irregular alignment with respect to cache line and memory page boundaries (which will tend to be at intervals of blocks of power-of-2 numbers of bytes). Hence, often power-of-2 instruction lengths may be preferred to avoid these implementation difficulties. However, there may be cases where one power-of-2 instruction length gives insufficient encoding space for the desired set of instructions, but the next largest power-of-2 size gives an encoding space which is vastly more than what is needed. By reserving additional bits as expansion bits which are architecturally constrained to have a predetermined value, this helps support instructions longer than one power-of-2 size while enabling hardware designers to avoid the full storage costs of storing instructions at the next largest power-of-2 size, since the architectural constraint associated with the expansion bits makes it practical to implement compression to avoid the expansion bits taking up storage space in memory and/or the instruction cache.

In some examples, the architectural encoding constraint further requires that: the set of functional bits and the set of one or more expansion bits are encoded fully within a C-bit container, where C is a fixed integer that is a power of 2; and no valid instruction is allowed to cross a boundary between C-bit containers. Hence, the front end circuitry, when pre-decoding or decoding instructions, can assume that these architectural encoding conditions are satisfied and need not expend any circuitry for dealing with cases where these conditions are not satisfied. This can greatly simplify the complexity of the front end circuitry (and hence provide more circuit-area-efficient and power-efficient hardware), because, for example, there is no need to deal with cases where a single instruction has its functional bits split across two separate cache lines, which would require additional buffering circuitry to “remember” the first part of one instruction while fetching the second part of the same instruction from a different cache line or memory page (and in the case of instructions crossing memory page boundaries could risk undesirable complexity in dealing with cases where different parts of the instructions are in different memory pages associated with different memory access permissions, or in virtual memory pages mapped by address translation mappings to non-contiguous regions of physical address space).

In some examples, each C-bit container comprises a single instruction represented by W functional bits, and the set of one or more expansion bits comprise C-W remaining bits of the C-bit container. While it may seem inefficient to dispose a W-bit instruction within a larger C-bit container leaving C−W bits effectively unused, those spare bits of the container can serve as expansion bits as discussed above, and so can be compressed out by hardware based on the architecturally defined assumption that they will have the predetermined value for all valid instructions in the instruction set.

In some examples, C/2≤W<C. It may seem counter-intuitive that it would be useful to dispose an instruction with C/2 functional bits in a C-bit container, leaving the other C/2 bits to be used as expansion bits. One might expect that, in this case, it would have been more efficient in terms of use of memory address space to encode each instruction within a C/2-bit container (i.e. to encode the instructions more conventionally without any expansion bits, simply as C/2-bit instructions where every bit of the instruction is a functional bit). However, in some examples, an ISA designer may anticipate that in the future it will become desirable to provide more than C/2 bits of encoding space for the functional bits of an instruction, even though currently there is not yet the need for more than C/2-bits of encoding space. That ISA designer may therefore design an expandable instruction set for which each instruction is encoded within a C-bit container to leave room for future expansion, but the current iteration of the ISA may still use only C/2 bits per container as functional bits of each instruction, leaving the other C/2 bits as expansion bits. This means software developers can start developing software using the expandable instruction set, with the expectation that the software may remain compatible with later processor designs which use a future version of the ISA with more than C/2 functional bits per instruction.

In some examples C/2<W<C. Hence, in this case, W is a non-power-of-2 integer, such that the functional bits of an instruction occupy more than half (but not all) of its corresponding C-bit container within the memory address space. As discussed earlier, this approach in combination with the constraint that the remaining C−W expansion bits are required to have the predetermined value can be extremely useful in enabling the amount of usable instruction encoding space for functional bits to expand beyond one power-of-2 size, without forcing hardware designers to incur the full hardware cost of the next power-of-2 size, while retaining a regular and predictable alignment of instructions relative to power-of-2 sized cache line or memory page boundaries.

The expandable instruction set could be used with any power-of-2 number of bits for the container size, C. However, this technique can be particularly useful where C=64. Many existing instruction sets use a 32-bit instruction length, but an encoding space of 2\hat{ }32 instruction encodings is starting to become strained for accommodating ever increasing demand for additional functionality. However, increasing to 64-bit instruction lengths may provide vastly more encoding space than is expected to be needed. Hence, the approach of providing 64-bit containers (C=64) encoding W-bit instructions, with W between 32 and 63 and C−W bits of the container designated as expansion bits constrained to have the predetermined value, can help support current or future expansion of the instruction set beyond the encoding space available from 32-bit length instructions, without forcing all hardware implementations to incur the undesirable cost of caching, decoding and conveying instructions which are the full 64 bits wide.

In an implementation encoding the W functional bits within a C-bit container, the program counter used to identify a given instruction may indicate an address aligned to the start of the C-bit container. Hence, the apparatus may comprise program counter advancement circuitry configured to increment a program counter address by a given increment per instruction when processing a sequence of instructions involving no taken branches, the given increment corresponding to a size of the C-bit container.

As discussed more fully below, it is also possible for each C-bit container to encode two or more instructions, each instruction including W functional bits and one or more expansion bits (possibly leaving some spare unused bits of the C-bit container which represent neither the functional bits nor the expansion bits of any of the two or more instructions). Hence, in some examples, the C-bit container comprises N instructions each comprising W functional bits and E expansion bits, where N is an integer greater than 1, and N*(W+E)≤C. This approach may help to improve efficiency of utilisation of memory address space, as by grouping multiple instructions per container this can increase the fraction of bits per container that are used as functional bits to represent actual instruction functionality. In this approach, the front end circuitry may support a branch operation specifying as a branch target any one of the N instructions encoded within a given C-bit container. As discussed further below, if each container comprises multiple instructions, the program counter advancement increment from one instruction to another may be variable depending on instruction alignment of each instruction within a given container, so no longer follows a simple increment by the container size as in the example above where each container comprises a single instruction.

Regardless of whether each container comprises one instruction or multiple instructions, it can be useful for the C-bit container to have an address which is C-bit aligned in a memory address space, to simplify instruction addressing.

While it is possible for the functional bits and expansion bits of a given instruction to be represented using a subset of bits at non-contiguous positions within the container, pre-decoding or decoding of instructions from the container can be simpler when the set of functional bits and the set of one or more expansion bits for the given instruction are represented by a contiguous set of bits within the C-bit container.

For example, the set of one or more expansion bits for the given instruction may be represented by a more significant portion of the C-bit container than the set of functional bits for the given instruction. This can help simplify hardware implementation because it means that, regardless of the number of functional bits and expansion bits supported for a particular ISA version, the functional bits may start at an address aligned to the least significant bit of the instruction, so instruction addressing using a program counter may remain the same across different ISA versions with different numbers of functional bits and expansion bits. This simplifies support for legacy software written for an older ISA version on an apparatus designed to use a newer ISA version with fewer expansion bits (and more functional bits) per instruction.

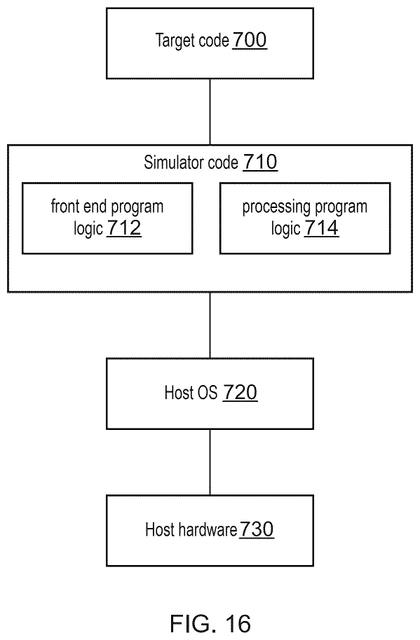

In some examples, the expandable instruction set mode may be the only instruction set mode supported by the apparatus. For example, there may be no other instruction set supported in hardware by the front end circuitry and processing circuitry, other than the expandable instruction set which has the architectural constraint that each instruction is required to have its one or more expansion bits set to encode the predetermined value (as seen from the simulation embodiment of FIG. 16 discussed further below, this does not exclude the option of being able to emulate other instructions sets using simulation software which remaps software of another instruction set into the natively supported expandable instruction set processed in the expandable instruction set mode).

Hence, some examples may be restricted to operating the front end circuitry and the processing circuitry in the expandable instruction set mode and may not support any mode which is not considered the expandable instruction set mode.

However, in some examples, the front end circuitry is configured to also support at least one further instruction set mode for which instructions to be processed are not required to satisfy said architectural encoding constraint used in the expandable instruction set mode. For example, control state defined in at least one register may control whether the front end circuitry and processing circuitry operates in the expandable instruction set mode or the at least one further instruction set mode. For example, the at least one further instruction set mode may be a mode supporting execution of software written according to a more conventional instruction set comprising instructions which do not include any expansion bits as discussed above. Supporting operating modes accommodating different instruction sets can be useful, for example, for supporting execution of legacy software written before the expandable instruction set described above was introduced.

The instructions of the expandable instruction set may be architecturally defined to include the one or more expansion bits described above, so that from a software perspective, each instruction occupies an amount of memory address space corresponding to the combined size of both the functional bits and the expansion bits. Nevertheless, it is not essential for the instructions to actually occupy this amount of storage space within memory storage circuitry. Some hardware system designers may choose to provide memory compression circuitry configured to compress a block of instructions by eliminating at least one expansion bit from a representation of the block of instructions stored in a memory system. This enables the hardware storage requirements for a block of program code to be reduced, while still retaining the software-designated meaning of each instruction. For example, a compression format may be used where a block of instructions is preserved in combination with metadata identifying the original structure of the compressed instructions (and eliminating at least one of the expansion bits from needing to be stored explicitly for each instruction). The compression circuitry may scan regions of memory to identify blocks of instructions for which each instruction in a given region has the expansion bits set to the predetermined value, and on detecting such a region may compress the instructions and store them more concisely using the compression format, to enable some of the hardware storage circuitry of the memory to be reused for storing other information.

The apparatus also comprises memory decompression circuitry configured to decompress a compressed block of instructions to restore the at least one expansion bit prior to supplying the decompressed block of instructions to the front end circuitry Hence, in implementations implementing memory compression to eliminate the expansion bits, when an instruction is prefetched for allocation into the instruction cache or fetched to be decoded and executed, the memory decompression circuitry can then restore the previously eliminated expansion bits so that (pre-)decode circuitry of the front end circuitry can detect whether the expansion bits had the predetermined value. Similarly, on a data read to a region of memory compressed using the memory compression circuitry, a read to an address corresponding to a compressed region may cause the read out value to correspond to the original uncompressed version of any instructions stored in that region.

According to some examples, an apparatus comprises front end circuitry configured to fetch and decode instructions; and processing circuitry configured to perform data processing operations in response to instructions fetched and decoded by the front end circuitry; in which: in a container-based instruction set mode for processing instructions from a fixed-length instruction set for which each instruction of the fixed-length instruction set is encoded using the same number of functional bits representing functionality of the instruction, the front end circuitry is configured to decode the instructions according to an encoding scheme in which each instruction is required to meet an architectural encoding constraint requiring that, for a given instruction processed in the container-based instruction set mode: the given instruction is one of a plurality of instructions encoded fully within a C-bit container, where C is a fixed power-of-2 integer; each instruction has W functional bits, where W is a fixed non-power-of-2 integer; and no valid instruction is allowed to cross a boundary between C-bit containers; and the front end circuitry is configured to support a branch operation specifying as a branch target any one of the plurality of instructions encoded within a given C-bit container.

Similar to the above discussion of C-bit containers for the expandable instruction set mode, it can be helpful to provide a container-based instruction set processed in the container-based instruction set mode of the apparatus, for which instructions with a non-power-of-2 number (W) of functional bits are packed inside power-of-2-sized C-bit containers. Valid encodings of the containers are constrained so that no valid instruction is allowed to cross a boundary between C-bit containers, to avoid hardware implementation difficulties caused by irregular instruction alignment with respect to cache line boundaries and memory page boundaries (which will typically be at intervals of a power-of-2 number of bytes). Hence, the hardware of the front end circuitry need not include more complex logic to handle cases where an instruction is split across different cache lines or memory pages. However, compared to packing each non-power-of-2-sized instruction individually inside a power-of-2-sized container, the utilisation of memory address space to represent instructions can be more efficient if multiple instructions each with W functional bits are packed inside a single C-bit container, as this can result in fewer bits remaining unused per container when encoding a given number of instructions. Nevertheless, each individual instruction within the C-bit container can act as a branch target of a branch operation, which reduces complexity for compilers as there is no need for the compiler to constrain selection of which instruction of a program code sequence is encoded at a particular position within the container based on expected branch target points within the program code sequence.

The plurality of instructions may have a fixed alignment pattern within the C-bit container. Hence, the relative pattern of alignment may be the same across each C-bit container, which simplifies implementation of circuit logic for instruction pre-decoding and/or decoding, as well as program counter advancement.

The container-based instruction set processed in the container-based instruction set mode may be a fixed-length instruction set for which each instruction processed in that mode has the same number (W) of functional bits.

Although it is possible for the instructions within a given C-bit container to be encoded using two or more sets of discontiguously located bits of the C-bit container, implementation of circuit logic to pre-decode and/or decode the instructions of the container can be simpler if the plurality of instructions are encoded using a contiguous portion of bits of the C-bit container. Hence, the unused bits not used to encode any of the instruction may be at a most significant or least significant end of the C-bit container (e.g. the most significant end, to simplify addressing of the first instruction of the container which is aligned to the least significant bit of the container).

The C-bit container may comprise one or more unused bits which do not represent any functional bits of the plurality of instructions. When W is not a power-of-2 integer then C is not an exact multiple of W and so there may be some unused bits spare which cannot represent any of the functional bits of the instructions within the container, but pad out the instructions to avoid any instruction crossing a container-boundary. These unused bits could be located at any bit of the C-bit container, but circuit implementation of decoding/pre-decoding circuitry and/or program counter advancement circuitry may be simplest if the unused bits comprise one or more most significant bits of the C-bit container.

In some examples, the front end circuitry comprises an instruction cache configured to cache instructions fetched from a memory system, and the front end circuitry may eliminate at least a subset of the unused bits from cached information representing one or more instructions obtained from the C-bit container. The unused bits may, in some ISA implementations, not be used for any architecturally defined purpose, so do not need to be stored in the instruction cache. By eliminating such unused bits prior to instruction caching, this can reduce the circuit area and power cost associated with caching of a given number of instructions.

In other examples, the unused bits of a C-bit container not needed for any functional bits of the instructions encoded by that container may be reused for other purposes. For example, the unused bits of a container may be used to encode a value that is reported to software on occurrence of an exception associated with any instruction encoded by the container. This could be helpful for tagging certain portions of software with a value which can be read by exception handlers to cause different exception responses for exceptions occurring in different program code regions, for example. Hence, in some examples, in response to an exception associated with an instruction encoded by a given C-bit container, the processing circuitry is configured to report, in a storage location accessible to software, a value specified by the unused bits of the given C-bit container. In this case, the “unused” bits not used as functional bits of an instruction may not be compressed out when storing the instructions to an instruction cache, but may be retained to assist with exception reporting.

The front end circuitry may identify instructions based on a program counter; and each of the plurality of instructions within a given C-bit container may correspond to a different encoding of the program counter. This enables branch operations to branch to any one of the instructions within the given C-bit container, by specifying as a branch target address the program counter encoding corresponding to the desired branch target instruction.

The program counter may comprise a first portion of bits identifying an address of the C-bit container and a second portion of bits identifying a selected instruction of the plurality of instructions within the C-bit container. In some examples, the first portion of bits may be naturally C-bit aligned in memory address space and may correspond to the address of the first instruction within the container (hence the second portion may be zero for the first instruction within the container, so that the first instruction is also C-bit aligned in memory address space).

The second portion of bits may take a value which distinguishes each individual instruction within the same C-bit container. The second portion could be encoded in a number of different ways.

In some examples, the second portion of bits specifies a byte offset of a byte of the C-bit container that encodes a first bit of the selected instruction. In some examples, each instruction within the C-bit container may have its start aligned to that byte address, in which case the byte offset specifies the offset between the start of the C-bit container and the first bit of the selected instruction. In other examples, the instructions may not necessarily be byte-aligned within the C-bit container (e.g. if W is not a multiple of 8, some instructions may start at a bit position part way through a byte), but nevertheless the second portion of bits of the program counter may be aligned to a byte offset, specifying the position of the byte that contains the first bit of the selected instruction. For each value of the second portion of the program counter, there can be a known predetermined relationship of the relative bit offset of the first bit of the instruction represented by that second portion relative to the start of the byte indicated by the second portion (that relative bit offset varying from one value of the second portion to another depending on the fixed alignment of instructions within a container). Specifying the program counter address using a byte offset for the second portion can be convenient because this means the program counter can more naturally be interpreted as a byte memory address, which is more consistent with other memory addressing which is typically at granularity of individual bytes.

Nevertheless, in other examples the second portion of bits could be encoded in other ways, such as with the second portion of bits specifying an instruction index corresponding to the selected instruction (the instruction index incrementing by 1 from one instruction to the next within a container, such that the first instruction of the container has index 0, the second instruction of the container has index 1, the third instruction of the container has index 2, etc.).

It is also possible for the byte offset indicated by the second portion to be represented by a compressed representation of the second portion using an encoding of fewer bits than in a standard binary representation of the byte offsets, since the number of instructions in one container may be less than the number of encodings available for the second portion. Some bits of the byte offset may be inferable from other bits, to give an opportunity for compression which can then free up other bits of the second portion for indicating other information.

Hence, there can be various ways in which the second portion of the program counter can be encoded, but in general this enables each instruction of the container to be distinguished as a potential branch target.

In some examples, when the first portion of the program counter is encoded to be a C-bit-aligned memory address pointing to the memory storage location of the C-bit container as a whole, this may mean that the least significant bit of the first portion should be located at a bit position within the program counter corresponding to a C-bit address boundary in memory address space. This therefore implies a certain number of bits available for use as the second portion of the program counter (encoded using the least significant portion of the program counter). For example, if C=128 (16 bytes) and encodes 3 instructions with 40 functional bits (5 bytes) each, this would imply that a byte address aligned to a 16-byte container boundary would be represented by an address with the lower 4 bits all set to 0. Hence, the second portion of the program counter would be represented by the lower 4 bits of the program counter, but distinguishing 3 instructions per container only requires 3 of the 16 encodings available for those lower 4 bits. Therefore, there can be unused encoding space in the second portion of the program counter which can be available for encoding other information.

Hence, in some examples, the second portion may also indicate further information other than an identification of the selected instruction. The spare encoding space not needed for identifying specific instructions packed within the same container can be reused for other purposes. For example, the further information may comprise an instruction set identifier identifying that the selected instruction is to be processed in the container-based instruction set mode (this could be useful, for example, to distinguish from program counters identifying instructions from another instruction set to be processed in a different mode).

The apparatus may comprise program counter advancement circuitry configured to advance the program counter by a variable increment amount per instruction during processing of a non-branching sequence of instructions. The amount by which the program counter advances from one instruction to the next may be variable due to the relative alignment of instructions with non-power-of-2 numbers of functional bits within a C-bit container, so that there may be some “jumps” from one instruction to the next which may be larger than others. When processing a code sequence not involving a taken branch, program counter advancement circuitry can generate the next program counter value as a function of the current program value. For example, the program counter advancement circuitry is configured to determine the variable increment amount according to a cyclic pattern corresponding to alignment of the plurality of instructions within the C-bit container. That cyclic pattern may be hard coded in the circuit logic hardware of the front end circuitry (e.g. with Boolean functions defining how a given bit of the second portion of the program counter is derived from values of the set of bits of the second portion of the program counter). The specific details of that logic may vary significantly depending on the values of W and C used for a given implementation. However, in general for any pair of W and C, it is possible to derive a set of logic functions that generate the next program counter value from the current program counter value, to take account of the pattern of alignment of each instruction within a given container. A specific example with W=36 and C=256 is shown below but it will be appreciated this is just one specific example.

The container-based instruction set mode can be particularly helpful when

W>32 (and hence C≥128 to ensure that two or more instructions with W functional bits can fit within a power-of-2 sized container). ISAs with 32-bit instruction length are starting to become strained in terms of accommodating the range of instructions desired to be supported, but increasing instruction length of every instruction to 64 bits may be overkill and would consume much greater storage cost in caches and memory. Hence, one might think that an instruction length between 32 and 64 bits would be useful, but if such non-power-of-2 sized instructions were packed contiguously in memory, this would cause system design headaches of instructions crossing page/cache-line boundaries. With the container-based approach of packing multiple non-power-of-2 sized instructions within a power-of-2 aligned C-bit container, the memory address space utilisation can get closer to the close-packed contiguous packing of the non-power-of-2 length instructions without introducing the problem of instructions crossing page/cache-line boundaries, and the instruction set can expand beyond 32-bit instruction length without wastefully consuming a full 64 bits per instruction.

In some examples, a size of the C-bit container is equal to a cache line size. A cache line is a data unit of a size corresponding to the granularity with which blocks of data from memory are allocated and replaced in a cache. Other examples, may implement a cache line size which corresponds to a plurality of C-bit containers. It will be appreciated that the choice of cache line size is a matter for a system designer of a particular processor implementation, so may not be architecturally defined in the ISA. However, if the cache line can be large enough to comprise at least one C-bit container, this can ensure that any instruction is decodable from a single cache line.

In some examples, the processing circuitry is configured to support sequential processing of at least two of the plurality of instructions encoded within the same C-bit container. For example, it is possible for two instructions in the same C-bit container to have a memory hazard, register hazard, structural hazard, so that they cannot be processed in parallel by the processing circuitry. It is possible for some implementations to process in parallel two or more instructions within the same C-bit container provided there is no hazard between the instructions that would preclude such parallel processing. Hence, there is no need to constrain the instructions which are allowed to be encoded within the same C-bit container such that the compiler guarantees there is no hazard between the instructions encoded in the same container. The front end circuitry and/or processing circuitry may include circuitry to detect hazards between instructions, and schedule whether the instructions within a given C-bit container are processed sequentially or at least partially in parallel depending on such hazard detection.

As for the expandable instruction set mode described above, the container-based instruction set mode may not be the only instruction set mode supported by the apparatus. In some examples, the front end circuitry is configured to also support at least one further instruction set mode for which instructions to be processed are not required to satisfy said architectural encoding constraint used in the container-based instruction set mode. For example, the at least one further instruction set mode may be a mode for supporting a legacy instruction set used for software written prior to the introduction of the container-based instruction set supported in the container-based instruction set mode.

In some examples, the container-based instruction set mode may be supported as an alternative to the expandable instruction set mode described above, with the apparatus supporting the container-based instruction set mode but not supporting use of expansion bits as described above.

In other examples, the container-based instruction set mode may be supported, in addition to the expandable instruction set mode described above (as two separate modes). A mode control value specified by a control register could be set, under software control, to select which instruction set mode is currently active.

However, it is also possible for a given operating mode of the apparatus to serve as both the expandable instruction set mode and as the container-based instruction set mode, so that each instruction within the C-bit container comprises, as further bits beyond the W functional bits, a set of one or more expansion bits constrained to specify a predetermined value for each instruction processed in the container-based instruction set mode. Hence, in this case the same operating mode serves as both the container-based instruction set mode and the expandable instruction set mode. In other words, a certain number N of instructions each comprising W functional bits and E expansion bits are disposed within a C-bit container, leaving C−N*(W+E) bits spare as unused bits. This approach can combine the advantages of both the expansion bits and use of containers described earlier, in supporting continued future expansion of the instruction set as well as improving memory utilisation by reducing the number of unused bits for a given block of instructions encoding within the same container.

Specific examples are now described with reference to the drawings.

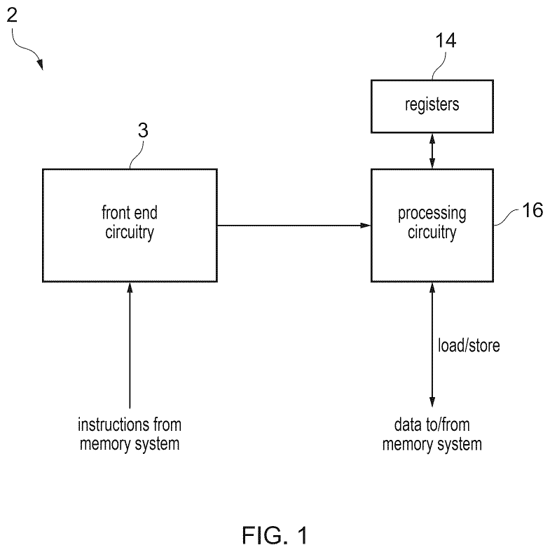

FIG. 1 schematically illustrates an example of a data processing apparatus 2 having front end circuitry 3 and processing circuitry 16. The front end circuitry 3 is responsible for fetching instructions from a memory system or instruction cache and decoding the instructions to generate micro-operations ready for processing by the processing circuitry (the micro-operations representing the decoded form of the instruction). Optionally, the front end circuitry 3 may also perform pre-decoding of instructions prior to caching in the instruction cache, so that pre-decode information can be derived from an instruction loaded from the memory system and the pre-decode information can be cached along with the instruction in the instruction cache. This enables the power cost of performing some decoding steps to be incurred once when the instruction is cached rather than multiple times when the same cached instruction is fetched multiple times for execution (e.g. when the instruction appears within a program loop to be iterated multiple times). As discussed further below, pre-decoding can also enable instructions to be stored in the instruction cache in a compressed format with fewer bits than in the architecturally defined representation of the instruction.

The processing circuitry 16 comprises execution units for executing different classes of processing operation corresponding to the micro-operations generated by the front end circuitry 3 (e.g. the classes of instructions may include load/store instructions, arithmetic/logical instructions, branch instructions, etc.). Registers 14 are provided to store operands for the operations performed by the processing circuitry 16. Results of processing operations can be written to the registers 14.

An instruction set architecture (ISA) defines the format with which each instruction is encoded to represent the functionality to be performed by the processing circuitry 16 in response to the instruction being fetched, decoded and issued for processing by the front end circuitry 3. The ISA may define an instruction set representing the set of instruction types to be supported by the front end circuitry 3 and processing circuitry 16, and for each instruction in the instruction set, the ISA defines an encoding format which sets out the various fields of the instruction encoding that represent an opcode (identifying instruction type) and other instruction parameters including, if applicable, a destination register specifier identifying a destination register to which a result of the instruction should be written, one or more source register specifiers and/or immediate values identifying source operands for the processing operation represented by the instruction, and any other parameters which may influence how the instruction is processed by the processing circuitry 16.

A common instruction length in use in many processor architectures is 32 bits, which provides encoding space for 2\hat{ }32 different instruction encodings. However, over time a 32-bit instruction encoding may become strained, as there may be constant pressure to accommodate new instructions being added as part of regular extensions to the architecture. One solution to this problem is to define a variable-length instruction set such that existing instructions can remain at 32 bits and new instructions could be added using 64-bit encodings. However, variable-length instruction sets create several complexities for hardware and software. These complexities cost power, performance, area, and development time. The issues mainly arise in the instruction caching and decode sections of the front end circuitry, because those blocks need to be able to deal with unaligned and unknown instruction boundaries. For example, the decode logic would need to serially scan instructions in a decode group to find instruction boundaries because the size of opcodes earlier in the group affect the alignment of opcodes later in the group.

Another option to expand the instruction encoding space would be to switch to a non-power-of-two instruction length (e.g. 48 bits). However, this comes with its own set of complexities such as dealing with instructions that cross cache line or memory page boundaries, as well as software complexities. For example, if an instruction crosses a cache line boundary (a cache line being the unit of memory address space that can be fetched from memory in a single transfer), this means the front end circuitry may need buffering circuitry to “remember” the first part of an instruction fetched from one cache line while waiting for the second part of the instruction obtained from another cache line, which introduces additional circuit area and timing complexities. Even worse, if an instruction can cross a memory page boundary, this risks different parts of the same instruction being in memory pages with different memory access attributes and/or different address translation mappings, which can lead to headaches such as only part of the instruction being accessible in a given operating state, or mapping of different parts of the same instruction onto physical memory regions with different access latencies or properties.

Given the issues with variable-length instruction sets and instructions with non-power-of-two instruction lengths, it would be desirable to use a fixed-length instruction set with a power-of-two instruction length, but for an instruction set architecture with, say, 32 bits, the next power of two would be 64 bits. This is a vast increase in the amount of encoding space (a 64-bit instruction length provides 2\hat{ }32 times the encoding space of a 32-bit instruction length), which is very unlikely ever to be needed, so defining a true 64-bit instruction length would be wasteful. Going to a full 64 bits would cut the instruction capacity of the instruction cache in half for a given byte capacity. It would also mean that all instruction-encoding-tracking hardware would double in size which would increase the size of the processor and put more timing pressure on instruction decoders. Hence, there would be a significant circuit area and power cost to increasing from a 32-bit instruction length to a 64-bit instruction length.

The above example refers to a challenge when seeking expansion beyond a 32-bit instruction length, but it will be appreciated that similar challenges may also apply to other size instruction sets. However, the techniques below can be particularly useful to expand beyond 32 bits of encoding space, as it is expected that an instruction length a little above 32 bits, but not as much as 64 bits, would provide an amount of encoding space likely to accommodate any envisaged future expansion needs.

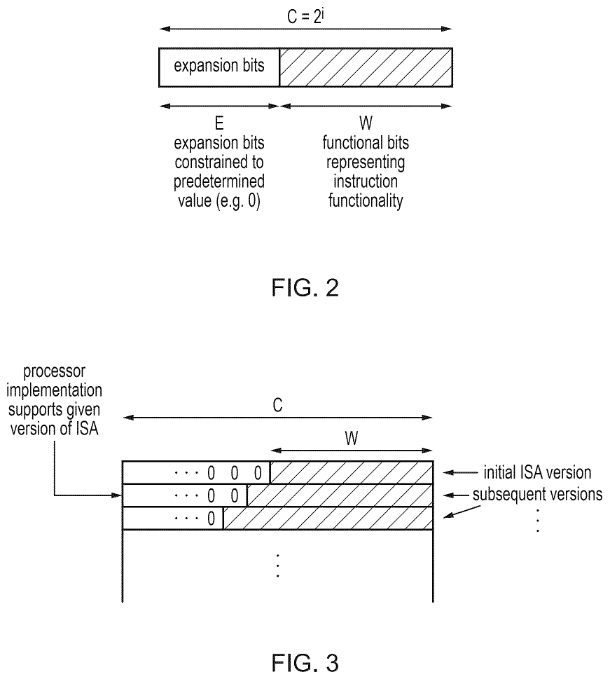

FIG. 2 shows an example of defining instructions according to an expandable instruction set where each instruction has W functional bits and is encoded fully within a fixed-size instruction container. The container is C bits wide where C is a power of two (C=2\hat{ }i). When stored in memory address space, each C-bit container is naturally aligned with respect to a C-bit block boundary (e.g. the address of the container is aligned to a byte address which is a multiple of C/8 bytes). Since the container is a power-of-2 size, it packs with a regular pattern in any power-of-2 sized cache line or memory page, so with this encoding it is not possible for any valid instruction to cross a boundary between cache lines or memory pages.

The W functional bits represent the instruction functionality of the instruction, which control the front end circuitry 3 and processing circuitry 16 to cause a corresponding processing operation to be performed. For example, the W functional bits may include the instruction opcode identifying the type of instruction and identifiers of any operands or other parameters defining the processing operation to be performed. W is an integer less than or equal to C and greater than or equal to C/2.

The container size C is a fixed size for a major revision(s) of the ISA (e.g. C=64). The functional bit length W is fixed for a given minor revision of the ISA, but can grow for subsequent minor revisions. The W functional bits are aligned starting at the least significant bit of the surrounding container C, and the remaining E most significant bits of the container are treated as expansion bits which are constrained to have a predetermined value for all valid instructions encoded in the expandable instruction set. In this example, E=C−W as the container only contains one instruction.

The predetermined value defined for the expansion bits could be any architecturally designated value (with all other bit patterns in the expansion bits treated as invalid instruction encodings for which an exception is to be signalled if there is an attempt to fetch an instruction having an invalidly encoded set of expansion bits). However, in one example, the predetermined value can be zero (i.e. a value where all of the E expansion bits are zero), which can simplify instruction decoding and compression schemes.

As shown in FIG. 3 (which is based on a particular example where the predetermined value is zero, but this is not essential), this approach enables successive ISA minor revisions over time to gradually expand the number of functional bits supported, by gradually converting additional expansion bits into functional bits. As an example, a first generation version of the ISA could have C=64 and W=32, e.g. with instructions from an existing 32-bit long instruction set being encoded as-is into bits [31:0] of the container C and bits [63:32] of C would be set to all zero. In a future generation that requires more opcode bits, W could increase to 33, retaining all existing encodings with C[32]==0 and adding new encodings with C[32]==1—i.e. providing an additional 2\hat{ }32 encodings not previously available. Bits [63:33] of C would be all zero. A third iteration of the ISA may increase W to 34, enabling new encodings with C[33]==1 to be used for valid instructions. Gradually, the number of expansion bits is reduced.

However, any specific hardware implementation of a processor only supports a given version of the ISA, with a fixed value for W (and E). For example, consider a processor implementation which implements the second version discussed with respect to FIG. 3, with

W=33. If the processor executes software written for an earlier version of the architecture, that legacy software continues to function correctly, because the existing encodings of the instructions supported in the earlier version (with 32 functional bits at bits [31:0] of the container and bit [32]==0) remain unchanged when moving to a later version of the ISA. On the other hand, if a processor supporting a given version executes software written for a later ISA version which includes instructions that assume a greater value of W than the value supported by that hardware processor implementation, then any instructions having the E expansion bits set to a value other than predetermined value will cause an exception to be signalled so that the newer introduced instructions not supported by that hardware platform can be emulated in software. For example, software including an instruction for the third generation ISA in FIG. 3 will have bit [33]==1 in some instructions, so those instructions cause the exception to be signalled on the hardware implementation expecting bits [63:33] of the container to all be 0. Hence, this approach can maintain inter-operability between software and hardware designed for different versions of the ISA using different values for W.

A hardware advantage of this scheme over a true 64-bit opcode is that, as any given hardware microarchitecture would be designed for a given revision of the architecture and therefore a given value of W, such microarchitecture could have front end circuitry 3 which drops the unused expansion bits from the container upon instruction cache linefill, meaning it would not need to cache all the expansion bits in the instruction cache nor pipeline those bits to instruction decoders, etc. The front end circuitry 3 may have pre-decoding circuitry which, on cache line fill into the instruction cache, checks whether the upper E expansion bits of a container loaded from memory have the predetermined value, and caches pre-decode information in the instruction cache indicating whether the instruction is valid, so that on an attempt to fetch the instruction for processing, a synchronous exception can be raised associated with that instruction, to trigger software emulation of the instruction unsupported by the current platform. Hence, the circuit logic for controlling signalling of the exception can be implemented without actually caching all the expansion bits in the instruction cache, e.g. by compressing the expansion bits to a single bit of pre-decode information representing whether the expansion bits were validly encoded, or adjusting the encoding of the W functional bits to a predetermined reserved value if the expansion bits were invalidly encoded.

Therefore, by defining the instruction set using an architectural encoding constraint that requires that each instruction has W functional bits and E expansion bits architecturally constrained to a predetermined value for all instructions, this enables expansion of usable encoding space beyond a power of 2 length, without incurring the full hardware cost of the next power of 2 instruction length. For example, for W=33, the growth in hardware cost for instruction cache capacity and instruction tracking components, relative to a simple 32 bit instruction length without expansion bits, would only be 3.125% ( 1/32), so this provides performance, power, and area benefits over a true 64-bit instruction set. Also, by disposing W functional bits within a power-of-2 sized container, this avoids the hardware complexities of densely packed non-power-of-2 length instructions consecutively in memory which would risk instructions crossing cache line and memory page boundaries.

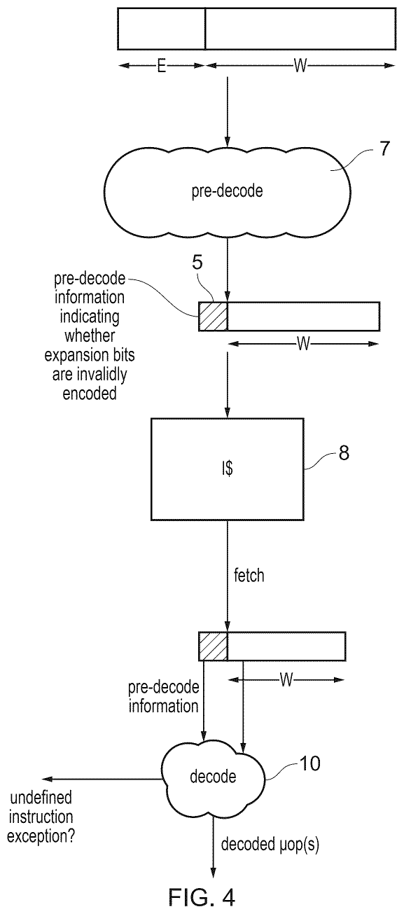

FIG. 4 illustrates in more detail an example of the front end circuitry 3 for handling instructions encoded according to the example of FIG. 2. The front end circuitry 3 comprises pre-decode circuitry 7, an instruction cache 8, and decode circuitry 10. On an instruction cache linefill (triggered either by a demand fetch request generated by the front end circuitry 3 when the instruction actually needs to be fetched for decoding and execution by the processing circuitry 16, or by a prefetch request to prefetch the instruction into the instruction cache 8 in advance of the time when the instruction actually needs to be executed), the pre-decode circuitry 7 pre-decodes the instruction to identify one or more properties of the instruction and generates pre-decode information 5 representing the identified properties. For example, the pre-decode circuitry 7 may identify whether the expansion bits E are validly encoded (set to the predetermined value) or invalidly encoded (set to any value other than the predetermined value). The pre-decode information 5 may indicate whether the expansion bits are validly or invalidly encoded. The pre-decode information 5 could also indicate other information about the instruction (e.g. some advance information about instruction type, which can simplify subsequent decode logic invoked at the time the instruction is actually fetched for processing). Performing some pre-decoding at the time of writing the instruction fetched from memory into the instruction cache 8 can help to save power at the subsequent decode circuitry 10, because the pre-decoding circuitry 7 acts once on the instruction at the time the instruction is allocated into the instruction cache, but that overhead may be amortized across multiple instances of the same instruction being fetched from the instruction cache 8 for decoding (e.g. when the instruction appears in a portion of code iterated multiple times in a program loop, or in a function that may be called from multiple different locations in a program). While FIG. 4 shows the pre-decode information 5 being separate from the W functional bits of the instruction, in other examples the pre-decode information indicating whether the expansion bits were validly encoded could be represented by the W functional bits of the instruction itself, e.g. by modifying the W functional bits to a predetermined invalid encoding if the E expansion bits did not take the predetermined value.

Having generated the pre-decode information 5 based on the E expansion bits, the E expansion bits can be eliminated prior to writing to the instruction cache 8, so this compresses the instruction representation in the cache 8 to avoid storing the full C container bits for each instruction. This saves a significant amount of circuit area and power compared to caching for a true C-bit instruction set.

On fetching a given instruction from the instruction cache 8, the front end circuitry 3 supplies the W functional bits and pre-decode information 5 obtained from the instruction cache 8 to the decode circuitry 10, which identifies based on the pre-decode information 5 whether an exception (e.g. undefined instruction exception type) should be signalled. If the pre-decode information 5 specifies that the E expansion bits of the corresponding container were invalidly encoded with a value other than the predetermined value, then the exception is signalled. If the expansion bits were validly encoded, this exception is not needed (unless there is another error associated with encoding of the W functional bits—in some cases the exception type used to signal invalidly encoded expansion bits could be the same exception type that is also used to deal with other classes of invalid instruction encoding). If no exception is needed, the decode circuitry 10 generates one or more micro-operations corresponding to the decoded instruction, and supplies those micro-operations to the processing circuitry 16 for execution.

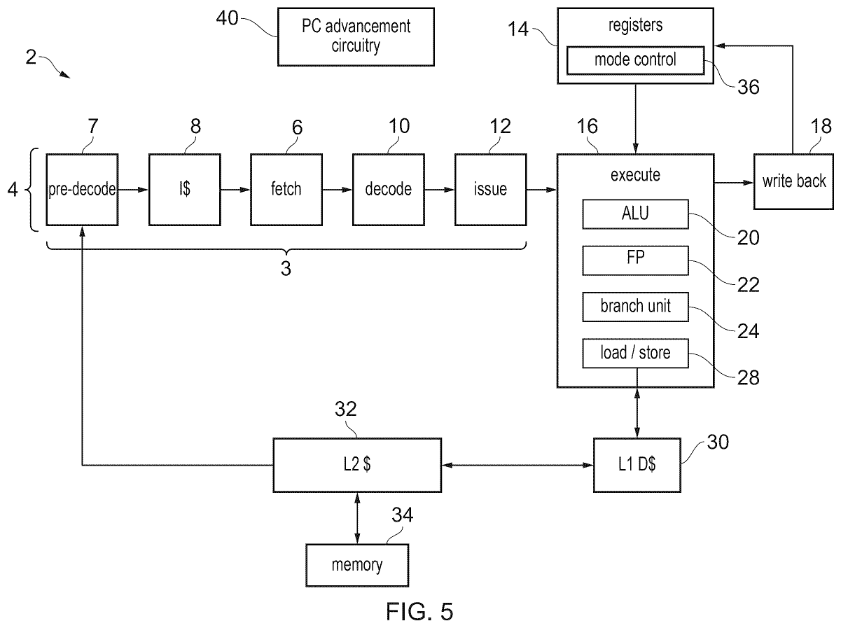

FIG. 5 schematically illustrates an example of the data processing apparatus 2, showing in more detail components of the front end circuitry 3 and processing circuitry 16. The data processing apparatus has a processing pipeline 4 which includes a number of pipeline stages. It will be appreciated that this is merely one example of possible pipeline architecture, and other systems may have additional stages or a different configuration of stages.

In this example, the pipeline stages include a pre-decode stage 7 for pre-decoding instructions obtained from a memory system; an instruction cache 8 for caching the pre-decoded instructions; a fetch stage 6 for fetching instructions from the instruction cache 8; a decode stage 10 for decoding the fetched program instructions to generate micro-operations (decoded instructions) to be processed by remaining stages of the pipeline; and an issue stage 12 for checking whether operands required for the micro-operations are available in a register file 14 and issuing micro-operations for execution once the required operands for a given micro-operation are available (or are guaranteed to become available by the time the micro-operation reaches the relevant point at which the operand is needed for execution of the micro-operation). In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation. The pre-decode stage 7, fetch stage 6, decode stage 10 and issue stage 12 may collectively be considered to correspond to the front end circuitry 3 described earlier. In some examples the front end stages could also include a register renaming stage for mapping architectural registers specified by program instructions or micro-operations to physical register specifiers identifying physical registers in the register file 14.

The pipeline 4 also has an execute stage 16 (corresponding to the processing circuitry mentioned earlier) for executing data processing operations corresponding to the decoded/issued micro-operations, by processing operands read from the register file 14 to generate result values; and a writeback stage 18 for writing the results of the processing back to the register file 14. The execute stage 16 includes various execution units for executing different classes of processing operation. For example the execution units may include an arithmetic/logic unit (ALU) 20 for performing arithmetic or logical operations, a floating-point unit 22 for performing operations on floating-point values, a branch unit 24 for evaluating the outcome of branch operations and adjusting the program counter which represents the current point of execution accordingly, and a load/store unit 28 for performing load/store operations to access data in a memory system. In this example the memory system include a level one data cache 30, a shared level two cache 32 and main system memory 34. It will be appreciated that this is just one example of a possible memory hierarchy and other arrangements of caches can be provided. The specific types of execution unit 20 to 28 shown in the execute stage 16 are just one example, and other implementations may have a different set of execution units or could include multiple instances of the same type of execution unit so that multiple micro-operations of the same type can be handled in parallel. It will be appreciated that FIG. 1 is merely a simplified representation of some components of a possible processor pipeline architecture, and the processor may include many other elements not illustrated for conciseness, such as branch prediction mechanisms or address translation or memory management mechanisms.

Hence, when implementing the expandable instruction set having instructions encoded as shown in FIG. 2, in at least one mode of operation (an expandable instruction set mode), the front end circuitry (e.g. pre-decode circuitry 7 and/or decode circuitry 10) decodes the instructions according to an encoding scheme where each instruction is required to meet an architectural encoding constraint that requires that each instruction comprises W functional bits representing the instruction functionality and a set of E expansion bits constrained to have the predetermined value. The front end circuitry 3 signals an exception if there is an attempt by the fetch stage 6 to fetch for processing an instruction detected as being from a container for which the expansion bits were invalidly encoded to a value other than the predetermined value (the invalidly-encoded expansion bits could be detected based on pre-decode information generated by the pre-decode circuitry 7 at the time of allocating the instruction into the instruction cache 8, even if the synchronous exception based on that invalid encoding is not raised until there is an attempt to fetch an instruction for which the pre-decode information indicates the invalidly-encoded expansion bits).

The expandable instruction set mode may not be the only instruction set mode supported by the apparatus 2. The registers 14 may include at least one control register storing a mode control value 36 which specifies a current instruction set mode. The instruction set mode may influence the encoding scheme with which instructions are assumed to be defined when fetched from memory, and hence the way in which those instructions are decoded by the front end. In some cases, at least one legacy instruction set mode may also be supported, enabling the same apparatus 2 to handle both software written according to a legacy instruction set not having the encoding constraints discussed for the expandable instruction set, and the expandable instruction set discussed above. The mode control value 36 in the registers 14 may be updated based on instructions executed by the processing circuitry 2, e.g. by executing a system register updating instruction, or alternatively could be updated by detecting, based on spare bits in a program counter used to track program flow, which instruction set a given instruction at a given program counter address belongs to, so that if there is a transition from one instruction set to another, this can be denoted by setting the instruction set indicating bits of the program counter accordingly when carrying out a branch to a branch target corresponding to a specified value of the program counter. Hence, there are a variety of ways in which multiple instruction sets could be supported in a modal manner within the same hardware platform.

As shown in FIG. 5, the apparatus may also have program counter advancement circuitry 40 for maintaining the program counter (PC) that tracks the current point of program flow reached by an executed program. Although FIG. 5 for conciseness shows a single instance of PC advancement circuitry 40, in practice the pipelined processing of instructions by the apparatus 2 means that while a later pipeline stage (e.g. the execute stage 16) is processing an older instruction from an earlier point of program flow, an earlier pipeline stage (e.g. the fetch stage 6) may be processing a younger instruction from a later point of program flow. Therefore, in some examples respective pipeline stages (e.g. the fetch 6 and execute stages 16) may maintain their own versions of a program counter which store values offset from one another based on the depth of the pipeline. Hence, references to PC advancement circuitry 40 below may refer to any of one or more instances of PC advancement circuitry 40 that may be present in the system.

A given instance of PC advancement circuitry 40 may, for sequences of instructions that do not involve any taken branch, advance the program counter sequentially to track progression of program flow sequentially from one instruction to the next. When a branch is taken, the program counter address may be updated non-sequentially based on the branch target address of the branch operation. Hence, when instructions are processed in the expandable instruction set mode based on the example of FIG. 2, each program counter address may be aligned to the least significant bit of the C-bit container, and each time an instruction is processed without a branch being taken, the program counter may be advanced by an address increment corresponding to the size of the C-bit container.

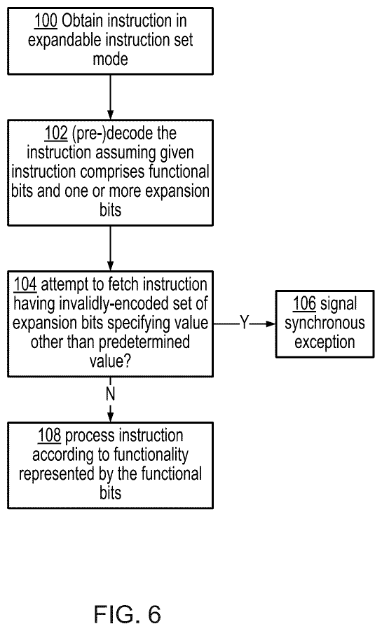

FIG. 6 shows an example method for processing instructions in the expandable instruction set mode. At step 100, the front end circuitry 3 obtains an instruction encoded according to the expandable instruction set mode. In some examples, the expandable instruction set mode could be the only supported instruction set mode, and so all instructions may be considered processed in that mode. In other examples, the expandable instruction set mode may be one of several supported instruction set modes, so the instructions may be processed in the expandable instruction set mode when the expandable instruction set mode has been set as the current mode, e.g. based on a system register updating instruction updating the mode indicating value 36 or as a consequence of fetching an instruction whose program counter includes an encoding to indicate that the fetched instruction is to be processed from the expandable instruction set mode. At step 102, the front end circuitry 3 pre-decodes or decodes the instruction, assuming that the given instruction comprises a number of functional bits and one or more expansion bits. At step 104, the front end circuitry 3 detects whether there has been attempt to fetch the instruction having an invalidly-encoded set of expansion bits set to a value other than a predetermined value, and if so a synchronous exception is signalled at step 106 (the exception is associated with information, e.g. the program counter, identifying the point of program flow corresponding to the instruction that triggered the exception). The detection at step 104 could be based on the original expansion bits themselves (in an implementation not implementing pre-decode circuitry 7), but often may be based on pre-decode information 5 generated by pre-decode circuitry 7 and cached with the instruction in the instruction cache 8. If the expansion bits for the instruction were validly encoded to specify the predetermined value (and assuming no other cause of exception arises), then at step 108, the front end circuitry 3 controls the processing circuitry 16 to process the instruction according to the functionality represented by the W functional bits of the instruction. In this case, the E expansion bits do not have any further influence on the processing operation performed by the processing circuitry 16, other than determining whether the exception should be signalled at step 104.

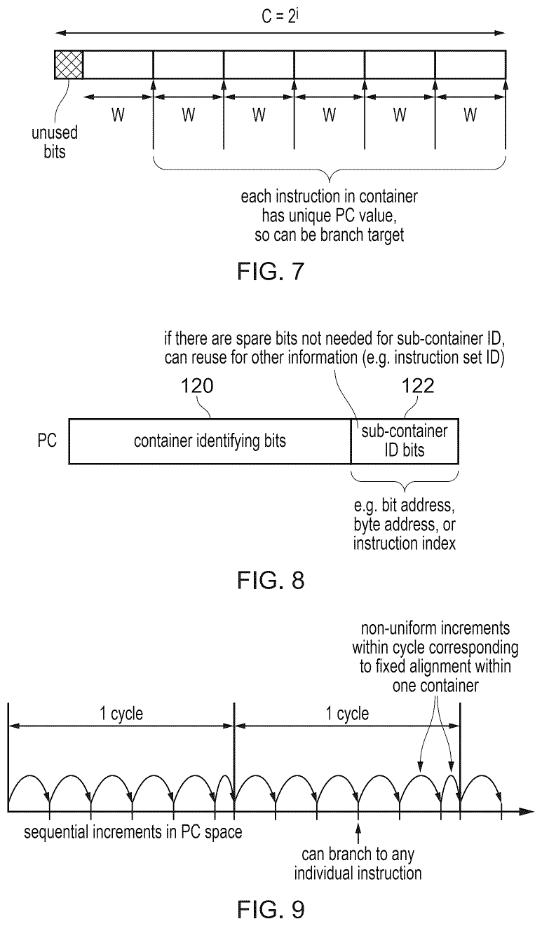

FIG. 7 shows another example encoding scheme for an instruction set processed in a container-based instruction set mode in which each instruction is required to meet an architectural encoding constraint requiring that each instruction is one of two or more instructions encoded within a power-of-2 sized container (a container having C bits where C=2\hat{ }i and i is an integer). Each instruction has W functional bits representing the instruction's functionality. W is not an exact power of 2. The container-based instruction set is a fixed-length instruction set because each instruction has the same number of functional bits. This avoids added complexity of variable-length instruction sets, as each instruction starts at a known location in the container and the starting point of one instruction does not depend on decoding of an earlier instruction. No valid instruction is allowed to cross a boundary between C-bit containers. The instructions do not need to be an exact fit within the container, so can leave some unused bits which do not represent any valid instruction—these unused bits help to pad out the container so that the next container starts from a regular alignment which is the same for each container. By using a fixed-size container with a power-of-2 number of bits to encode a number of non-power-of-2 sized instructions, and not allowing any instructions to cross the container boundary, this avoids the hardware problems mentioned above that would be caused by instructions crossing cache line or memory page boundaries.

The container-based instruction set can be helpful in cases where one power-of-2 instruction length gives insufficient encoding space but the next power-of-2 length would give vastly more encoding space than what is needed. By grouping multiple non-power-of-2 length instructions into a larger container, the number of unused bits per instruction can be reduced because the grouping can be selected to bring the end of the last instruction in the container closer to the end of the container than would be possible if each instruction was in its own power-of-2-sized container. For example, FIG. 7 shows an example where 6 W-bit instructions are within a C-bit container. For example, if W=40 and C=256, the 6 instructions may occupy 240 bits of the container leaving just 16 bits unused (shared across 6 instructions). In contrast, if each 40-bit instruction had been located in a 64-bit container, this would leave 24 bits unused per instruction, i.e. 144 bits spare across 6 instructions. Hence, the container-based instruction set encoding grouping together multiple instructions in one container can be much more efficient in terms of utilisation of address space for a stored program. For another example, C=128 and W=40, and 3 40-bit instructions could be packed into the 128-bit container leaving 8 bits spare, which is again more efficient than if 3 40-bit instructions were packed into 64-bit containers leaving 24 bits spare per instruction.

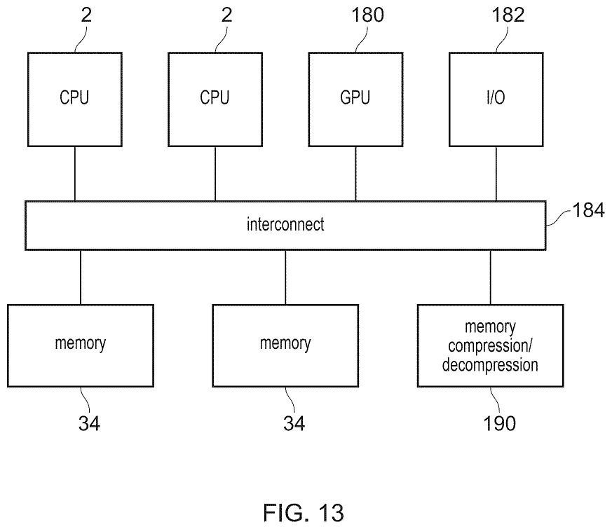

In some examples, the unused bits of a container may not serve any architectural purpose. The front end circuitry 3 may therefore have freedom to eliminate the unused container bits from being stored in an instruction cache. The unused bits may also be compressed out when the instructions are stored in memory. Although the unused bits, if not used for any architectural purpose, could take any arbitrary bit value, to support options for memory system designers to implement compression of stored programs when stored in memory (see FIG. 13 described below), it may be useful to constrain the unused bits to specify a particular predetermined value (e.g. 0), so that compression hardware can detect regions of code where the unused bits can be compressed out.

In other examples, the unused bits could be used for purposes other than encoding instructions. For example, a container identifier arbitrarily selected by a compiler of program code could be specified in the unused bits of a given container. When an exception arises for a given instruction in a given container, the container identifier of that container could be written to a known location (e.g. an exception status register or predetermined address in memory). This allows software developers or compilers to tag regions of program code with a particular identifier which could enable exception handler software routines to be developed which take different actions depending on the region of code for which the exception occurred, or to enabling software logging of which regions experience exceptions.

In the container-based instruction set, each instruction within the container has a unique program counter value, so can be distinguished as a branch target for a branch operation, allowing a branch operation to branch to any one of the instructions within the container. Hence, each instruction within the container is architecturally viewed as part of a sequential program for which program flow sequentially traverses from one instruction to the next within the container, rather than viewing the instructions within the container as sub-operations to be performed in parallel for a shared value of a program counter. For an implementation of the apparatus 2 shown in FIG. 1 or 5 supporting the container-based instruction set mode, when scheduling execution of a first instruction and second instruction obtained from the same container, the front end circuitry 3 (e.g. the issue stage 12) is free to schedule the first and second instructions to be executed either in parallel in the same processing cycle or sequentially in different processing cycles. At least some of the time, such first and second instructions may end up being scheduled sequentially. There is no restriction on which instructions are grouped together within the same container—for example there is no need for a compiler to guarantee that there are no dependency hazards between instructions encoded in the same container. It is perfectly acceptable for one instruction in the container to be a consumer instruction which specifies a source operand which corresponds to a result value generated by an earlier producer instruction in the same container—in that case the issue stage 12 may schedule the instructions based on detecting the register hazard to ensure that the consumer instruction takes the result of the producer instruction (e.g. in some cases by scheduling the instructions to execute sequentially in different cycles, or by using forwarding to forward the result direct from the producer instruction to the consumer instruction).

The program counter advancement circuitry 40 maintains a program counter to track a current point of program flow. As shown in FIG. 8, the program counter may comprise a first portion 120 and a second portion 122. The first portion 120 comprises container-identifying bits which represent an address of the C-bit container that contains the instruction represented by the program counter. The second portion 122 comprises sub-container identifier bits which distinguish each individual instruction within a given container. The address indicated in the first portion 120 may be considered to point to the least significant byte of the C-bit container. For example, with C=128 (16-byte containers), a 16-byte aligned address would have its lower 4 bits all set to 0, so the second portion 122 may be represented by bits [3:0] of the program counter and the first portion by bit [4] onwards. For C=256, a 32-byte aligned address would have its lower 5 bits all set to 0, so the second portion 122 may be represented by bits [4:0] of the program counter and the first portion by bit [5] onwards. By aligning the first portion to the container size (and ensuring the first instruction at the least significant portion of the container corresponds to a second portion 122 of zero), the program counter corresponding to the first instruction in the container is simply the address of the container itself.

The sub-container identifier bits within the second portion 122 can be encoded in a number of different ways. In one example, the position of a given instruction is encoded using a byte address which indicates which byte of the container contains the first bit of the corresponding instruction.

For example, with the C=128, W=40 example from above, the three instructions in the container start at bits 0, 40, 80 respectively, which are within bytes 0, 5, 10 respectively. Hence, in some examples the second portion 122 could be encoded as 0b0000, 0b0101, 0b1010 for the three instructions in the same container. This has the advantage that the program counter address for a given instruction is simply the byte address at which the start of that instruction would appear in memory. In other examples, the byte addresses 0, 5, 10 can be compressed into fewer bits of encoding space, since, say, the upper 2 bits of the 4-bit encodings above can be inferred from the lower 2 bits (the upper 2 bits are always the same as the lower two bits). Hence, byte offsets could be represented by the second portion 122 of program counter bits in a format other than a simple binary representation of the byte offset.

If the number of functional bits W per instruction is not a multiple of 8, then some instructions start at a bit position that is not aligned to a byte address. For example, with C=256, W=34, seven 34-bit instructions can fit in a 256-bit container, and the instructions start at bit positions 0, 34, 68, 102, 136, 170, 204 respectively, so the bytes of the container that contain the first bit of each instruction would be bytes 0, 4, 8, 12, 17, 21, 25. Hence, the values of the second portion 122 of the program counter could indicate those byte positions, and the front end circuitry 3 may have circuit logic which recognises that when a byte position of 4, say, is indicated by the second portion of the program counter, the first bit of the corresponding instruction actually appears at the third bit position of that byte, corresponding to bit [34] of the container as mentioned earlier, while for a byte position of 17 the first bit of the corresponding instruction starts at the first bit position of the byte, corresponding to bit [136] of the container. Hence, the circuit logic of the front end circuitry may include circuitry which offsets the bit position at which the start of an instruction is read relative to the indicated byte address, by an amount specific to the particular value of the second portion 122 of the program counter.

Another approach to encoding the second portion 122 can be to specify an instruction index in the second portion, which runs consecutively from 0 upwards for each successive instruction of the container. With this approach, the three 40-bit instructions in the C=128, W=40 example could be denoted by second portions 122 of 0, 1 and 2 respectively. In this case, the circuit logic in the front end circuitry would map a given instruction index to the corresponding relative bit position within the container at which the start of the instruction occurs.

As is clear from the examples above, the number of instructions in one container may be less than the number of encodings available in the second portion 122 of the program counter, when the boundary between the first and second portions 120, 122 is aligned to correspond to the container size C. For example, the C=128, W=40 example has 4 bits for the second portion 122 but only uses 3 of the 16 encodings of the second portion 122 to denote valid branch points for instructions. This means there can be spare bits (or at least, spare encodings) which can be reused for other information, such as an instruction set identifier which indicates that this instruction is to be decoded in the container-based instruction set mode (as opposed to another mode such as a mode used to decode a legacy instruction set). Encoding an instruction identifier in any spare bits of the program counter can be useful as it means that a compiler setting branch target address operands for branches can use the spare encodings of the second portion 122 to indicate the point in program flow at which a change of instruction set is to occur, to avoid needing another instruction separate from the branch instruction to be executed to update the mode indicating value 36. The mode indicating value 36 can be updated automatically as a consequence of detecting from the program counter that there has been a change of instruction set. When spare encodings in the second portion 122 are to be reused for other purposes, the encoding of the second portion 122 using an instruction index (or another compressed format of the byte offset encodings such as the one discussed earlier) can make it simpler to reclaim unused encoding space because the encodings corresponding to valid branch points are compressed into a contiguous region of encoding space leaving at least one bit unused for the sub-container instruction identifying bits. Nevertheless, even if all bits of the second portion 122 are needed to represent the sub-container instruction identifier, there may still be spare encodings which could be reclaimed to indicate other information (e.g. two or more encodings could be allocated to represent the same instruction as a branch target, but which particular of those encodings is selected may distinguish other information such as the instruction set identifier).

As shown in FIG. 9, when the container-based instruction set is used and the program counter is encoded as shown in FIG. 8, the amount by which the program counter advances from one instruction to the next can be variable, depending on the fixed alignment of instructions within a container. When traversing a region of program code sequentially in a non-branching program flow sequence, the advancement increments jumping from one instruction to the next can be different when jumping across the unused bits at the end of one container to advance to the start of the next container, compared to when jumping between instructions within the same container. Even when advancing between instructions in the same container, the increment of the program counter can be by different amounts depending on the instruction alignment relative to a byte—e.g. if the second portion 122 is a byte offset, then in the example with W=34 discussed above, the advancement increment can be either 4 bytes or 5 bytes.

Hence, in general, the program counter advancement circuitry 40 may apply a cyclic pattern to determining how to advance the program counter from one instruction to the next, with a pattern of increments cycling through a fixed sequence. The increment to be applied at a given time depends on the current value of the second portion 122 of the program counter.

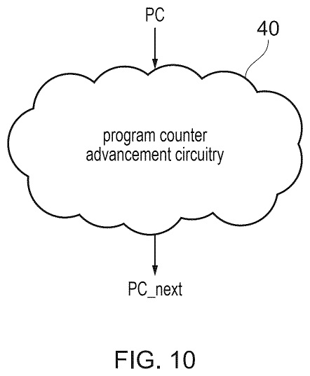

Hence, as shown in FIG. 10, the program counter advancement circuitry determines the next program counter value, PC_next, as a function of the current program counter value, PC. The particular logical functions used to derive PC_next from PC may depend on the particular values of C and W in use for a given implementation of the container-based instruction set.

As an example only, consider an example where C=256 and W=36, so that 7 36-bit instructions are packed into a 32-byte container, with 4 spare bits. The second portion 122 of the program counter will comprise the least significant 5 bits of the program counter (to ensure the first portion 120 aligns to the container address). In this case, the instructions are not all byte-aligned, but their bit position is simply a function of the second portion 122 of the program counter. In an implementation which assumes the program counter remains a byte address, so that the program counter value for a given instruction points to the address of the byte that contains the first bit of the instruction, then the instructions within the container will have byte addresses of 0, 4, 9, 13, 18, 22, 27. Hence, the program counter advancement circuitry 40 may have Boolean logic circuitry to calculate the second portion 122 of the next value of the program counter, PC_next, based on the second portion 120 of the current value of the program counter, PC, using the following logic:
PC_next[0]=(~PC[3] & PC[2])|(PC[3] & ~PC[2] & ~PC[1])
PC_next[1]=(PC[4] & ~PC[0])|(PC[2] & PC[0])
PC_next[2]=~PC[2] & (~PC[1]|~PC[0])
PC_next[3]=(PC[3]\hat{ }PC[2]) & (~PC[1]|~PC[0])
PC_next[4]=(PC[3] & PC[2])|(PC[4] & ~PC[0]).
   where & represents AND, | represents OR, ~ represents NOT, \hat{ } represents XOR. Meanwhile, the first portion 120 of PC_next can be calculated as PC_next[63:5]=PC[63:5]+&PC[4:3]. Of course, this is just one particular example for a particular encoding scheme, and the specific Boolean functions to be used will depend on the values of C and W selected for a given instruction set. However, it serves to illustrate that the circuit logic for advancing the program counter by a variable amount is not complex to implement.

Another observation is that with a byte address for the second portion 122 of the program counter, the second portion 122 has a very sparse encoding, using 5 bits to encode 7 instruction locations and so leaving many encodings spare. In many cases, a subset of the bits of the byte address indicated by the second portion 122 can be inferred from another subset of bits of the second portion 122, so that it is not necessary to specify all bits of the byte address explicitly, freeing up other bits of the second portion 122 for other information such as the instruction set identifier as mentioned above. For example, with the C=256 W=36 example above, PC[1:0] can actually be inferred from PC[4:2], so the storage form of the PC can actually use PC_storage[1:0] to store additional information such as an instruction set identifier, and the hardware can calculate PC[1:0] from PC_storage[4:2] when needed to access memory when fetching a branch target.

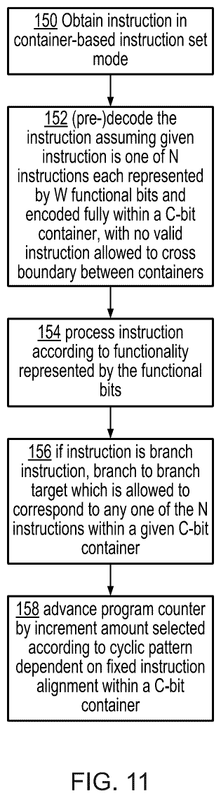

Hence, the apparatus of FIGS. 1 and 5 may in some examples support a container-based instruction set mode. FIG. 11 illustrates a method for processing instructions in the container-based instruction set mode. At step 150, an instruction is obtained by the front end circuitry 3 for processing in the container-based instruction set mode. In some examples, the container-based instruction set mode could be the only supported instruction set mode, and so all instructions may be considered processed in that mode. In other examples, the container-based instruction set mode may be one of several supported instruction set modes, so the instructions may be processed in the container-based instruction set mode when the container-based instruction set mode has been set as the current mode, e.g. based on a system register updating instruction updating the mode indicating value 36 or as a consequence of fetching an instruction whose program counter includes an encoding to indicate that the fetched instruction is to be processed from the container-based instruction set mode.

At step 152, pre-decoding circuitry 7 or decoding circuitry 10 of the front end circuitry 3 decodes the instruction assuming that the instruction is one of N (N>1) instructions each represented by W functional bits that are encoded fully within a C-bit container with no valid instruction being allowed to cross a boundary between containers (W is not a power of 2). Hence, there is no need for the front end circuitry 3 to include buffering circuitry to buffer part of an instruction while waiting for another container to be fetched. At step 154, the front end circuitry 3 controls the processing circuitry 16 to process the instruction according to a functionality represented by the W functional bits of the instruction. At step 156, if the instruction is identified to be a branch instruction, and the branch is taken for that instruction, the branch operation causes the program counter to be updated to cause a branch to a branch target instruction which is allowed to correspond to any one of the N instructions within a given C-bit container (the branch target address of the branch specifying a first portion 120 identifying the address of the given C-bit container and a second portion 122 identifying a particular one of the N instructions of the given C-bit container). At step 158, if no branch has been taken, the program counter advancement circuitry 40 advances the program counter by an increment amount selected according to a cyclic pattern which depends on the fixed instruction alignment within a C-bit container. For example, the next program counter value for the second portion 122 may be selected as a function of the previous value of the second portion 122 as discussed above.

The above examples discuss two instruction set modes that could be supported: an expandable instruction set mode and a container-based instruction set mode. Some implementations may only support one or other of these modes. Other implementations may support both modes as alternative instruction set modes, selectable based on the mode control value 36.

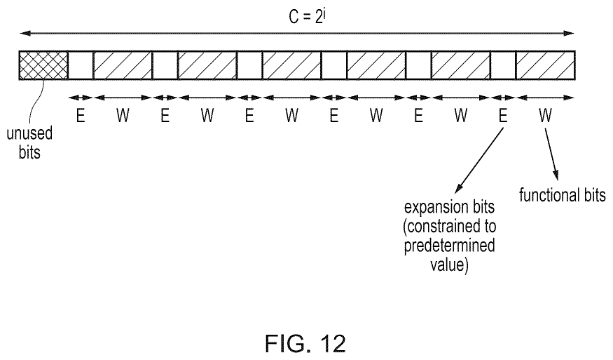

However, as shown in FIG. 12 it is also possible to combine features of both modes so that a single instruction set mode behaves as both the expandable instruction set mode and the container-based instruction set mode. In this example, as in the container-based instruction set mode described above, two or more instructions are packed into a C-bit container of fixed power-of-2 length, leaving some unused bits at the end of the container. However, in this example, each instruction within the container has W functional bits and E expansion bits, and as in the expandable instruction set mode described earlier, the expansion bits are constrained to specify a predetermined value (e.g. 0) for each valid instruction. In this example, the program counter is encoded as in the container-based instruction set mode described with reference to FIG. 8 above, and advances by an irregular amount as discussed for FIGS. 9 and 10. On an attempt to fetch an instruction from a given container, the front end circuitry 3 detects (e.g. based on pre-decode information set when the instruction was allocated into the instruction cache 8) whether the E expansion bits for that instruction have the predetermined value, and if not causes a synchronous exception to be generated (the exception is associated with information identifying the program counter of the affected instruction). The expansion bits (and optionally the unused bits of the container) can be compressed out when storing instructions to the instruction cache 8, to avoid incurring the full cost of storing all container bits in the instruction cache.

Hence, the example of FIG. 12 combines advantages of both encoding schemes:
leaving room for future expansion using the expansion bits, but in cases where it is unlikely that many expansion bits will be needed, grouping multiple expandable instructions into one container can increase the fraction of bits in a stored program that are used for meaningful functional bits of instructions.

FIG. 13 shows an example of a processing system that includes at least one processor (e.g. central processing unit, CPU) 2, which corresponds to the apparatus 2 described earlier with respect to FIGS. 1 and/or 5. At least one CPU 2 supports one or both of the expandable instruction set mode and container-based instruction set mode discussed above. The CPUs 2 access memory 34 via a memory system interconnect 184. Access to the memory 34 is shared with one or more other access requesters, such as a graphics processing unit (GPU) 180 or input/output (I/O) device 182.

In this example, the system also includes memory compression/decompression circuitry 190 for compressing/decompressing regions of program code encoded according to one or both of the expandable instruction set mode and container-based instruction set mode discussed above. The expansion bits and unused container bits mentioned earlier occupy space in the architecturally defined address space, but do not necessarily need to be stored in the stored representation of a program stored in memory. Some micro-architectural system designers may choose to implement memory compression/decompression circuitry 190 which can scan regions of memory to detect regions where the data stored in a given region matches the fixed encoding rules of the expandable instruction set mode and/or container-based instruction set mode. For example, for an example using an encoding similar to FIG. 2, the compression circuitry 190 may identify regions in which the upper E bits of a C-bit block are set to the predetermined value. For the example encoding of FIG. 7, the compression circuitry 190 may identify regions for which the unused bits at the upper end of a C-bit container have a predetermined value. For the example encoding of FIG. 12, the compression circuitry 190 may identify regions for which the unused bits at the upper end of a C-bit container have a first predetermined value and the various pockets of expansion bits E have a second predetermined value (the first and second predetermined values could be the same, e.g. 0, or different). When detecting a block of multiple C-bit instruction containers having the expected encoding pattern, the compression circuitry 190 can compress those blocks by eliminating the unused bits and/or expansion bits and representing the remaining functional bits of the block of instructions in a more compact form, to reduce the memory footprint occupied by that block of instructions. The decompression circuitry 190 may decompress the block when an instruction fetch or data read to the architectural addresses corresponding to the block is detected, to restore the original architecturally defined format of the instruction containers before passing the instructions to the front end circuitry 3. Alternatively, the compression circuitry 190 may simply store an identifier indicating that the compressed block of instructions had the valid encoding format, which may be sufficient for the front end circuitry 3 to determine how to identify and cache instructions from the block of instructions. In some examples, it may not even be necessary for the compression circuitry 190 to generate an identifier indicating that the encoding format was valid, because the front end circuitry 3 can assume that if the expansion bits for a given instruction had not taken the predetermined value, then the compression circuitry 190 would not have compressed the block of data in the first place. It will be appreciated that the decision on whether to implement memory compression/decompression circuitry 190 is a decision for the designer of a specific processor/memory system, so is not required by the ISA. However, this indicates that, even though one might expect that the use of expansion bits and unused bits might lead to less efficient use of memory storage, this is not necessarily the case and some memory systems may provide compression even in the underlying memory, not just in the instruction cache.

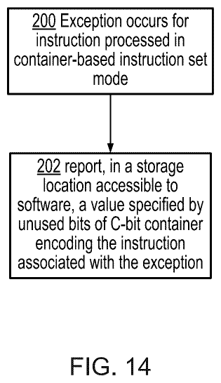

FIG. 14 illustrates steps for an example using the container-based instruction set mode, based on an encoding where the otherwise unused bits in a C-bit container are reused to provide a software-specified tag value which is to be reported for an exception. At step 200, an exception occurs for an instruction processed in the container-based instruction set mode. At step 202, in response to the exception, exception handling circuitry of the processor reports, using a storage location accessible to software (e.g. a control register or a memory location corresponding to a predetermined address), a value specified by the unused bits of the C-bit container that encoded the instruction associated with the exception.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

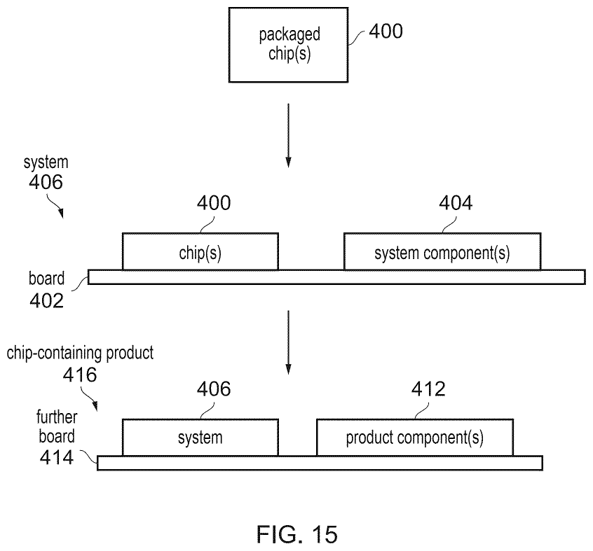

As shown in FIG. 15, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

FIG. 16 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 730, optionally running a host operating system 720, supporting the simulator program 710. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 730), some simulated embodiments may make use of the host hardware, where suitable.

The simulator program 710 may be stored on a computer-readable storage medium (which may be a non-transitory medium), and provides a program interface (instruction execution environment) to the target code 700 (which may include applications, operating systems and a hypervisor) which is the same as the interface of the hardware architecture being modelled by the simulator program 710. Thus, the program instructions of the target code 700, including instructions processed in the expandable instruction set mode and/or container-based instruction set mode described above, may be executed from within the instruction execution environment using the simulator program 710, so that a host computer 730 which does not actually have the hardware features of the apparatus 2 discussed above can emulate these features.

For example, the simulator code 710 may include front end program logic 712 configured to fetch and decode instructions of the target program code according to the architectural encoding constraints discussed above for the expandable instruction set mode and/or container-based instruction set mode; and processing program logic 714 configured to control the host data processing apparatus to perform data processing corresponding to the instructions decoded by the front end program logic 712. The front end program logic 712 could for example include instructions for extracting the functional bits of an instruction of the target code from within its C-bit container, and instructions defining “if-then-else” functionality or conditional branch instruction functionality which selects which subsequent instructions of the simulator code 710 are executed based on analysis of the encoding of the functional bits of the instruction of the target code 700. The processing program logic 714 may comprise function routines which are conditionally selected by the instruction front end program logic 712 based on the instruction encoding of the instruction. The front end program logic 712 and/or processing program logic 714 may also advance a program counter by an amount dependent on the relative instruction alignment within a container, as in the examples above. If an expandable instruction set mode is supported, the front end program logic 712 may cause a simulated exception to be indicated, if the decoded instruction is associated with invalidly-encoded expansion bits having a value other than the predetermined value.

Such a simulator program 710 can be helpful for software developers who are developing software for a new version of the ISA, to enable the software to be developed and tested before any real hardware supporting that ISA version is ready yet. This can allow software development for the new ISA version to be developed in parallel with ongoing development of hardware supporting the new ISA version.

Some examples are set out in the following clauses:
A1. An apparatus comprising:
   front end circuitry configured to fetch and decode instructions; and
   processing circuitry to perform data processing operations in response to instructions decoded by the front end circuitry; in which:
   in an expandable instruction set mode, the front end circuitry is configured to decode the instructions according to an instruction encoding scheme in which each instruction is required to meet an architectural encoding constraint requiring that, for a given instruction processed in the expandable instruction set mode:
      the given instruction comprises a set of functional bits representing functionality of the given instruction, and a set of one or more expansion bits; and
      the set of one or more expansion bits is constrained to specify a predetermined value.
A2. The apparatus according to clause A1, in which the front end circuitry is configured to signal an exception in response to detecting an attempt to fetch for processing an instruction having an invalidly-encoded set of one or more expansion bits specifying a value other than the predetermined value.
A3. The apparatus according to clause A2, in which the exception is a synchronous exception associated with information identifying a point of program flow associated with the instruction having the invalidly-encoded set of one or more expansion bits.
A4. The apparatus according to any of clauses A2 and A3, in which:
   in response to an attempt to fetch for processing a target instruction from an instruction cache, the front end circuitry is configured to determine whether to signal the exception based on cached pre-decode information stored in the instruction cache, the cached pre-decode information specifying whether the set of one or more expansion bits for the target instruction have the predetermined value.
A5. The apparatus according to any preceding clause, in which the front end circuitry comprises:
   an instruction cache configured to cache instructions fetched from a memory system; and
   pre-decoding circuitry configured to pre-decode an instruction allocated to the instruction cache and to eliminate at least a subset of the set of one or more expansion bits from cached information representing that instruction in the instruction cache.
A6. The apparatus according to any preceding clause, in which the given instruction comprises W functional bits, where W is a non-power-of-2 integer.
A7. The apparatus according to any preceding clause, in which the predetermined value has an encoding for which each of the set of one or more expansion bits is 0.
A8. The apparatus according to any preceding clause, in which the architectural encoding constraint further requires that:
   the set of functional bits and the set of one or more expansion bits are encoded fully within a C-bit container, where C is a fixed integer that is a power of 2; and
   no valid instruction is allowed to cross a boundary between C-bit containers.
A9. The apparatus according to clause A8, in which the C-bit container comprises a single instruction comprising W functional bits, and the set of one or more expansion bits comprise C−W remaining bits of the C-bit container.
A10. The apparatus according to clause A9, in which C/2≤W<C.
A11. The apparatus according to any of clauses A9 and A10, in which C/2<W<C.
A 12. The apparatus according to any of clauses A9 to A11, in which C=64.
A13. The apparatus according to any of clauses A8 to A12, comprising program counter advancement circuitry configured to increment a program counter address by a given increment per instruction when processing a sequence of instructions involving no taken branches, the given increment corresponding to a size of the C-bit container.
A14. The apparatus according to clause 8, in which the C-bit container comprises N instructions each comprising W functional bits and E expansion bits, where N is an integer greater than 1, and N*(W+E)≤C.
A15. The apparatus according to clause A14, in which the front end circuitry is configured to support a branch operation specifying as a branch target any one of the N instructions encoded within a given C-bit container.
A16. The apparatus according to any of clauses A8 to A15, in which the C-bit container has an address which is C-bit aligned in a memory address space.
A17. The apparatus according to any of clauses A8 to A16, in which the set of functional bits and the set of one or more expansion bits for the given instruction are represented by a contiguous set of bits within the C-bit container.
A18. The apparatus according to clause A17, in which the set of one or more expansion bits for the given instruction is represented by a more significant portion of the C-bit container than the set of functional bits for the given instruction.
A19. The apparatus according to any preceding clause, in which the front end circuitry is configured to also support at least one further instruction set mode for which instructions to be processed are not required to satisfy said architectural encoding constraint used in the expandable instruction set mode.
A20. The apparatus according to any preceding clause, comprising memory compression circuitry configured to compress a block of instructions by eliminating at least one expansion bit from a representation of the block of instructions stored in a memory system.
A21. The apparatus according to clause A20, comprising memory decompression circuitry configured to decompress a compressed block of instructions to restore the at least one expansion bit prior to supplying the decompressed block of instructions to the front end circuitry.
A22. A system comprising:
   the apparatus of any preceding clause, implemented in at least one packaged chip;
   at least one system component; and
   a board,
   wherein the at least one packaged chip and the at least one system component are assembled on the board.
A23. A chip-containing product comprising the system of clause A22, wherein the system is assembled on a further board with at least one other product component.
A24. Computer-readable code for fabrication of an apparatus according to any of clauses A1 to A21.
A25. A computer program comprising instructions which, when executed by a host data processing apparatus, control the host data processing apparatus to provide an instruction execution environment for execution of target program code, the computer program comprising:
   front end program logic configured to fetch and decode instructions of the target program code; and
   processing program logic configured to control the host data processing apparatus to perform data processing operations in response to the instructions fetched and decoded by the front end program logic; in which:
   in an expandable instruction set mode, the front end program logic is configured to decode the instructions according to an encoding scheme in which each instruction is required to meet an architectural encoding constraint requiring that, for a given instruction processed in the expandable instruction set mode:
      the given instruction comprises a set of functional bits representing functionality of the given instruction, and a set of one or more expansion bits; and
      the set of one or more expansion bits is constrained to specify a predetermined value.
A26. a Storage Medium Storing the Computer Program of Clause A25.
A27. A method comprising:
   fetching and decoding instructions using front end circuitry; and
   in response to the instructions fetched and decoded by the front end circuitry, performing data processing operations using processing circuitry; in which:
   in an expandable instruction set mode, the instructions are decoded according to an instruction encoding scheme in which each instruction is required to meet an architectural encoding constraint requiring that, for a given instruction processed in the expandable instruction set mode:
      the given instruction comprises a set of functional bits representing functionality of the given instruction, and a set of one or more expansion bits; and
      the set of one or more expansion bits is constrained to specify a predetermined value.
B1. An apparatus comprising:
   front end circuitry configured to fetch and decode instructions; and
   processing circuitry configured to perform data processing operations in response to instructions fetched and decoded by the front end circuitry; in which:
   in a container-based instruction set mode for processing instructions from a fixed-length instruction set for which each instruction of the fixed-length instruction set is encoded using the same number of functional bits representing functionality of the instruction, the front end circuitry is configured to decode the instructions according to an encoding scheme in which each instruction is required to meet an architectural encoding constraint requiring that, for a given instruction processed in the container-based instruction set mode:
      the given instruction is one of a plurality of instructions encoded fully within a C-bit container, where C is a fixed power-of-2 integer;
      each instruction has W functional bits, where W is a fixed non-power-of-2 integer; and
      no valid instruction is allowed to cross a boundary between C-bit containers; and
   the front end circuitry is configured to support a branch operation specifying as a branch target any one of the plurality of instructions encoded within a given C-bit container.
B2. The apparatus according to clause B1, in which the plurality of instructions have a fixed alignment pattern within the C-bit container.
B3. The apparatus according to any of clauses B1 and B2, in which the plurality of instructions are encoded using a contiguous portion of bits of the C-bit container.
B4. The apparatus according to any of clauses B1 to B3, in which the C-bit container comprises one or more unused bits which do not represent any functional bits of the plurality of instructions.
B5. The apparatus according to clause B4, in which the unused bits comprise one or more most significant bits of the C-bit container.
B6. The apparatus according to any of clauses B4 and B5, in which the front end circuitry comprises an instruction cache configured to cache instructions fetched from a memory system; and
   the front end circuitry is configured to eliminate at least a subset of the unused bits from cached information representing one or more instructions obtained from the C-bit container.
B7. The apparatus according to any of clauses B4 and B5, in which in response to an exception associated with an instruction encoded by a given C-bit container, the processing circuitry is configured to report, in a storage location accessible to software, a value specified by the unused bits of the given C-bit container.
B8. The apparatus according to any of clauses B1 to B7, in which the front end circuitry is configured to identify instructions based on a program counter; and
   each of the plurality of instructions within a given C-bit container corresponds to a different encoding of the program counter.
B9. The apparatus according to clause B8, in which the program counter comprises a first portion of bits identifying an address of the C-bit container and a second portion of bits identifying a selected instruction of the plurality of instructions within the C-bit container.
B10. The apparatus according to clause B9, in which the second portion of bits specifies a byte offset of a byte of the C-bit container that encodes a first bit of the selected instruction.
B11. The apparatus according to clause B9, in which the second portion of bits specifies an instruction index corresponding to the selected instruction.
B12. The apparatus according to any of clauses B9 to B11, in which the second portion also indicates further information other than an identification of the selected instruction.
B13. The apparatus according to clause B12, in which the further information comprises an instruction set identifier identifying that the selected instruction is to be processed in the container-based instruction set mode.
B14. The apparatus according to any of clauses B8 to B13, comprising program counter advancement circuitry configured to advance the program counter by a variable increment amount per instruction during processing of a non-branching sequence of instructions.
B15. The apparatus according to clause B14, in which the program counter advancement circuitry is configured to determine the variable increment amount according to a cyclic pattern corresponding to alignment of the plurality of instructions within the C-bit container.
B16. The apparatus according to any of clauses B1 to B15, in which W>32 and C≥128.
B17. The apparatus according to any of clauses B1 to B16, in which a size of the C-bit container is equal to a cache line size.
B18. The apparatus according to any of clauses B1 to B17, in which the processing circuitry is configured to support sequential processing of at least two of the plurality of instructions encoded within the same C-bit container.
B19. The apparatus according to any of clauses B1 to B18, in which each instruction within the C-bit container comprises, as further bits beyond the W functional bits, a set of one or more expansion bits constrained to specify a predetermined value for each instruction processed in the container-based instruction set mode.
B20. The apparatus according to any of clauses B1 to B19, in which the front end circuitry is configured to also support at least one further instruction set mode for which instructions to be processed are not required to satisfy said architectural encoding constraint used in the container-based instruction set mode.
B21. A system comprising:
   the apparatus of any of clauses B1 to B20, implemented in at least one packaged chip;
   at least one system component; and
   a board,
   wherein the at least one packaged chip and the at least one system component are assembled on the board.
B22. A chip-containing product comprising the system of clause B21, wherein the system is assembled on a further board with at least one other product component.
B23. Computer-readable code for fabrication of an apparatus according to any of clauses B1 to B22.
B24. A computer program comprising instructions which, when executed by a host data processing apparatus, control the host data processing apparatus to provide an instruction execution environment for execution of target program code, the computer program comprising:
   front end program logic configured to fetch and decode instructions of the target program code; and
   processing program logic configured to control the host data processing apparatus to perform data processing operations in response to the instructions fetched and decoded by the front end program logic; in which:
   in a container-based instruction set mode for processing instructions from a fixed-length instruction set for which each instruction of the fixed-length instruction set is encoded using the same number of functional bits representing functionality of the instruction, the front end program logic is configured to decode the instructions according to an encoding scheme in which each instruction is required to meet an architectural encoding constraint requiring that, for a given instruction processed in the container-based instruction set mode:
      the given instruction is one of a plurality of instructions encoded fully within a C-bit container, where C is a fixed power-of-2 integer;
      each instruction has W functional bits, where W is a fixed non-power-of-2 integer; and
      no valid instruction is allowed to cross a boundary between C-bit containers; and
   the front end program logic is configured to support a branch operation specifying as a branch target any one of the plurality of instructions encoded within a given C-bit container.
B25. A method comprising:
   fetching and decoding instructions using front end circuitry; and
   in response to the instructions fetched and decoded by the front end circuitry, performing data processing operations using processing circuitry; in which:
   in a container-based instruction set mode for processing instructions from a fixed-length instruction set for which each instruction of the fixed-length instruction set is encoded using the same number of functional bits representing functionality of the instruction, the instructions are decoded according to an encoding scheme in which each instruction is required to meet an architectural encoding constraint requiring that, for a given instruction processed in the container-based instruction set mode:
      the given instruction is one of a plurality of instructions encoded fully within a C-bit container, where C is a fixed power-of-2 integer;
      each instruction has W functional bits, where W is a fixed non-power-of-2 integer; and
      no valid instruction is allowed to cross a boundary between C-bit containers; and
   the front end circuitry is configured to support a branch operation specifying as a branch target any one of the plurality of instructions encoded within a given C-bit container.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
front end circuitry configured to fetch and decode instructions; and
processing circuitry to perform data processing operations in response to instructions decoded by the front end circuitry; in which:
in an expandable instruction set mode, the front end circuitry is configured to decode the instructions according to an instruction encoding scheme in which each instruction is required to meet an architectural encoding constraint requiring that, for a given instruction processed in the expandable instruction set mode:
the given instruction comprises a set of functional bits representing functionality of the given instruction, and a set of one or more expansion bits; and
the set of one or more expansion bits is constrained to specify a predetermined value.

2. The apparatus according to claim 1, in which the front end circuitry is configured to signal an exception in response to detecting an attempt to fetch for processing an instruction having an invalidly-encoded set of one or more expansion bits specifying a value other than the predetermined value.

3. The apparatus according to claim 2, in which the exception is a synchronous exception associated with information identifying a point of program flow associated with the instruction having the invalidly-encoded set of one or more expansion bits.

4. The apparatus according to claim 2, in which:
in response to an attempt to fetch for processing a target instruction from an instruction cache, the front end circuitry is configured to determine whether to signal the exception based on cached pre-decode information stored in the instruction cache, the cached pre-decode information specifying whether the set of one or more expansion bits for the target instruction have the predetermined value.

5. The apparatus according to claim 1, in which the front end circuitry comprises:
an instruction cache configured to cache instructions fetched from a memory system; and
pre-decoding circuitry configured to pre-decode an instruction allocated to the instruction cache and to eliminate at least a subset of the set of one or more expansion bits from cached information representing that instruction in the instruction cache.

6. The apparatus according to claim 1, in which the given instruction comprises W functional bits, where W is a non-power-of-2 integer.

7. The apparatus according to claim 1, in which the predetermined value has an encoding for which each of the set of one or more expansion bits is 0.

8. The apparatus according to claim 1, in which the architectural encoding constraint further requires that:
the set of functional bits and the set of one or more expansion bits are encoded fully within a C-bit container, where C is a fixed integer that is a power of 2; and
no valid instruction is allowed to cross a boundary between C-bit containers.

9. The apparatus according to claim 8, in which the C-bit container comprises a single instruction comprising W functional bits, and the set of one or more expansion bits comprise C−W remaining bits of the C-bit container.

10. The apparatus according to claim 9, in which C/2≤W<C.

11. The apparatus according to claim 9, in which C/2<W<C.

12. The apparatus according to claim 8, in which the C-bit container comprises N instructions each comprising W functional bits and E expansion bits, where N is an integer greater than 1, and N*(W+E)≤C.

13. The apparatus according to claim 8, in which the set of functional bits and the set of one or more expansion bits for the given instruction are represented by a contiguous set of bits within the C-bit container.

14. The apparatus according to claim 13, in which the set of one or more expansion bits for the given instruction is represented by a more significant portion of the C-bit container than the set of functional bits for the given instruction.

15. The apparatus according to claim 1, in which the front end circuitry is configured to also support at least one further instruction set mode for which instructions to be processed are not required to satisfy said architectural encoding constraint used in the expandable instruction set mode.

16. A system comprising:
the apparatus of claim 1, implemented in at least one packaged chip;
at least one system component; and
a board,
wherein the at least one packaged chip and the at least one system component are assembled on the board.

17. A chip-containing product comprising the system of claim 16, wherein the system is assembled on a further board with at least one other product component.

18. A non-transitory storage medium storing computer-readable code for fabrication of an apparatus according to claim 1.

19. A non-transitory storage medium storing a computer program comprising instructions which, when executed by a host data processing apparatus, control the host data processing apparatus to provide an instruction execution environment for execution of target program code, the computer program comprising:
front end program logic configured to fetch and decode instructions of the target program code; and
processing program logic configured to control the host data processing apparatus to perform data processing operations in response to the instructions fetched and decoded by the front end program logic; in which:
in an expandable instruction set mode, the front end program logic is configured to decode the instructions according to an encoding scheme in which each instruction is required to meet an architectural encoding constraint requiring that, for a given instruction processed in the expandable instruction set mode:
the given instruction comprises a set of functional bits representing functionality of the given instruction, and a set of one or more expansion bits; and
the set of one or more expansion bits is constrained to specify a predetermined value.

20. A method comprising:
fetching and decoding instructions using front end circuitry; and
in response to the instructions fetched and decoded by the front end circuitry, performing data processing operations using processing circuitry; in which:
in an expandable instruction set mode, the instructions are decoded according to an instruction encoding scheme in which each instruction is required to meet an architectural encoding constraint requiring that, for a given instruction processed in the expandable instruction set mode:
the given instruction comprises a set of functional bits representing functionality of the given instruction, and a set of one or more expansion bits; and
the set of one or more expansion bits is constrained to specify a predetermined value.
